(19) United States
(12) Patent Application Publication
(10) Pub. No.: US 2025/0150197 A1
(43) Pub. Date: May 8, 2025

(54) ULTRA HIGH RELIABILITY TRIGGER FRAME

(71) Applicant: NXP USA, Inc., AUSTIN, TX (US)

(72) Inventors: Liwen Chu, San Ramon, CA (US); Kiseon Ryu, San Diego, CA (US); Huizhao Wang, San Jose, CA (US); Ken Kinwah Ho, San Jose, CA (US); Hongyuan Zhang, Fremont, CA (US)

(21) Appl. No.: 18/932,916

(22) Filed: Oct. 31, 2024

Related U.S. Application Data
(60) Provisional application No. 63/595,634, filed on Nov. 2, 2023.
(60) Provisional application No. 63/606,181, filed on Dec. 5, 2023.

(51) Int. Cl. H04L 1/00; H04L 5/00

(52) U.S. Cl. CPC H04L 1/0008; H04L 5/0044

(57) ABSTRACT

Methods and apparatus for generating trigger frames that solicit PPDUs from one or more client devices. In an example method, a trigger frame is generated in accordance with the IEEE 802.11bn amendment (UHR) to the IEEE 802.11 standard. The method begins by determining a time duration requirement (or padding field length requirement) for preparing an uplink transmission from a client device. A trigger frame is generated (e.g., by an access point) that includes a frame check sequence (FCS) field, a padding field, and an intermediate FCS value that is included in the padding field. In an example, the dedicated fields of the trigger frame do not explicitly indicate the location of the intermediate FCS value. For a protected trigger frame, a MIC value is further included in the padding field. In other examples, the intermediate FCS value is included within one or more User Info fields of the trigger frame.

### CROSS REFERENCE TO RELATED APPLICATIONS

The present U.S. Utility patent application claims priority pursuant to 35 U.S.C. § 119(e) to U.S. Provisional Application No. 63/595,634, entitled “UHR TRIGGER FRAME”, filed Nov. 2, 2023, and U.S. Provisional Application No. 63/606,181, entitled “UHR TRIGGER FRAME”, filed Dec. 5, 2023, both of which are hereby incorporated herein by reference in their entirety and made part of the present U.S. Utility Patent Application for all purposes.

### BACKGROUND OF THE INVENTION

### Field of the Invention

This invention relates generally wireless communications, and more specifically to frame check sequence values for trigger frames used in wireless communications.

### Description of Related Art

Wireless local area networks (WLANs) have evolved rapidly over the past couple of decades, including WLANs that conform to the Institute of Electrical and Electronics Engineers (IEEE) 802.11 family of standards. A typical 802.11-based WLAN may be formed by one or more access points (APs) that provide a shared wireless communication medium for servicing a number of client devices or stations (STAs). In particular, an AP manages a Basic Service Set (BSS) that is identified by a Basic Service Set Identifier (BSSID) and advertised by the AP. The AP periodically broadcasts beacon frames to enable STAs within wireless range of the AP to establish and maintain communication links with the AP.

More recent versions of the IEEE 802.11 standards have added support for trigger-based uplink communications to enhance network throughput. For example, the 802.11ax amendment to the IEEE 802.11 standard introduced a trigger frame format that can be used to solicit trigger-based (TB) physical layer (PHY) protocol data units (PPDUs) from one or more client devices. A trigger frame can allocate wireless channel resources for uplink transmission of the TB PPDUs and indicate to client devices how the TB PPDUs are to be configured. The capabilities of the trigger frame format have been enhanced in the 802.11be amendment to the IEEE 802.11 standard to accommodate new features and capabilities introduced by the amendment.

### BRIEF DESCRIPTION OF THE DRAWINGS

One or more embodiments will now be described by way of example only with reference to the accompanying drawings, in which:

FIG. 1 illustrates an example of a multi-link communications system in accordance with embodiments of the present disclosure;

FIG. 2 illustrates an example of a trigger frame format that may be used in accordance with embodiments of the present disclosure;

FIG. 3 depicts another example of a trigger frame format that may be used in accordance with embodiments of the present disclosure;

FIG. 4 depicts an example of a Special User Info field format of a trigger frame that may be used in various embodiments of the present disclosure;

FIG. 5 depicts an example of a User Info List field of a trigger frame that may be used in various embodiments of the present disclosure;

FIG. 6 illustrates an example of a trigger frame padding field including an intermediate FCS value and PN+MIC Exist field in accordance with embodiments of the present disclosure;

FIG. 7 illustrates an example of a trigger frame padding field including an intermediate FCS value and PN+MIC field in accordance with embodiments of the present disclosure;

FIG. 8 illustrates an example of a trigger frame padding field including an intermediate FCS value, an PN+MIC field, and announcement fields in accordance with embodiments of the present disclosure;

FIG. 9 illustrates an example of a trigger frame padding field including an intermediate FCS value in accordance with embodiments of the present disclosure;

FIG. 10 illustrates an example of a User Info List field including an intermediate FCS value in accordance with embodiments of the present disclosure;

FIG. 11 illustrates an example of a User Info List field including an intermediate FCS value and PN+MIC field in accordance with embodiments of the present disclosure;

FIG. 12 illustrates another example of a User Info List field including an intermediate FCS value in accordance with embodiments of the present disclosure;

FIG. 13 illustrates another example of a User info List field including an intermediate FCS value in accordance with an embodiment of the present disclosure.

FIG. 14 illustrates an example of User Info fields including intermediate FCS values in accordance with embodiments of the present disclosure;

FIG. 15 illustrates an example of a Special User Info field and User Info fields including intermediate FCS values in accordance with embodiments of the present disclosure;

FIG. 16 illustrates an example of User Info fields including intermediate FCS values and MIC values in accordance with embodiments of the present disclosure;

FIG. 17 illustrates an example of User Info fields including a UHR PN+MIC field utilized as an intermediate FCS value in accordance with an embodiment of the present disclosure;

FIG. 18 illustrates an example of a User Info field including an intermediate FCS location field in accordance with an embodiment of the present disclosure;

FIG. 19 illustrates an example of a MU-RTS trigger frame including an intermediate FCS value in accordance with an embodiment of the present disclosure;

FIG. 20 is a logic diagram illustrating an example process for generating a UHR trigger frame;

FIG. 21 is a logic diagram illustrating another example process for generating a UHR trigger frame; and

FIG. 22 illustrates an example of an access point according to an embodiment of the present disclosure.

### DETAILED DESCRIPTION

The various implementations described in the following description relate generally to trigger-based communications to support new wireless communication protocols, and more particularly to trigger frame formats that support wireless communication features associated with the IEEE 802.11bn amendment (also referred to as Ultra High Reliability or “UHR” or “Wi-Fi 8”), and future generations, of the IEEE 802.11 standard. In some aspects, a UHR trigger frame may be generated to solicit a trigger-based (TB) physical layer (PHY) protocol data unit (PPDU) from one or more client devices (also referred to as stations or “STAs”).

As used herein, the term “non-legacy” may refer to PPDU formats and communication protocols conforming with the IEEE 802.11bn amendment to the IEEE 802.11 standard (“802.11bn”) as well as future generations/amendments. In contrast, the term “legacy” may be used herein to refer to PPDU formats and communication protocols conforming to the IEEE 802.11be (also referred to as Extremely High Throughput or “EHT” or “Wi-Fi 7”) or IEEE 802.11ax (also referred to as High Efficiency or “HE” or “Wi-Fi 6/6E”) amendments to the IEEE 802.11 standard, or earlier generations of the IEEE 802.11 standard, but not conforming to all mandatory features of 802.11bn or future generations of the IEEE 802.11 standard. In some implementations, a UHR trigger frame may be configurable to support multiple versions of the IEEE 802.11 standard. For example, a UHR trigger frame may be configured in accordance with a non-legacy trigger frame format or a legacy trigger frame format (e.g., to solicit a legacy TB PPDU from one or more STAs).

Particular implementations of the subject matter described in the present disclosure can be implemented to realize one or more of the following potential advantages. By soliciting the transmission of non-legacy TB PPDUs, the UHR trigger frame may support gains in data throughput achievable in accordance with the IEEE 802.11bn amendment of the IEEE 802.11 standard. Among other examples, the UHR trigger frame of the described implementations may enable non-legacy TB PPDUs to be transmitted over bandwidths of up to 320 MHz and above, on up to 16 spatial streams. By designing the UHR trigger frame format to support multiple versions of the IEEE 802.11 standard, aspects of the present disclosure may help ensure that the UHR trigger frame format is backwards compatible with legacy STAs. As a result, aspects of the present disclosure provide a single trigger frame design that can be used to concurrently solicit legacy and non-legacy PPDUs. Further, a UHR trigger frame implemented according to the present disclosure may account for differing trigger frame formats with minimal reliance on bits reserved in earlier versions of the trigger frame format, thereby permitting greater design flexibility when enabling other new standardized features.

In an example method according to the present disclosure, a trigger frame is generated in accordance with the IEEE 802.11bn amendment to the IEEE 802.11 standard. The method begins by determining a time duration requirement (or padding field length requirement) for preparing an uplink transmission from a client device. A trigger frame is generated (e.g., by an access point) that includes a frame check sequence (FCS) field, a padding field, and an intermediate FCS value that is included in the padding field. For a protected trigger frame, a PN+MIC field is further included in the padding field. In yet another example, the intermediate FCS value and/or PN+MIC field is included within User Info fields of the trigger frame. These and other trigger frame formats according to the present disclosure are described more fully below.

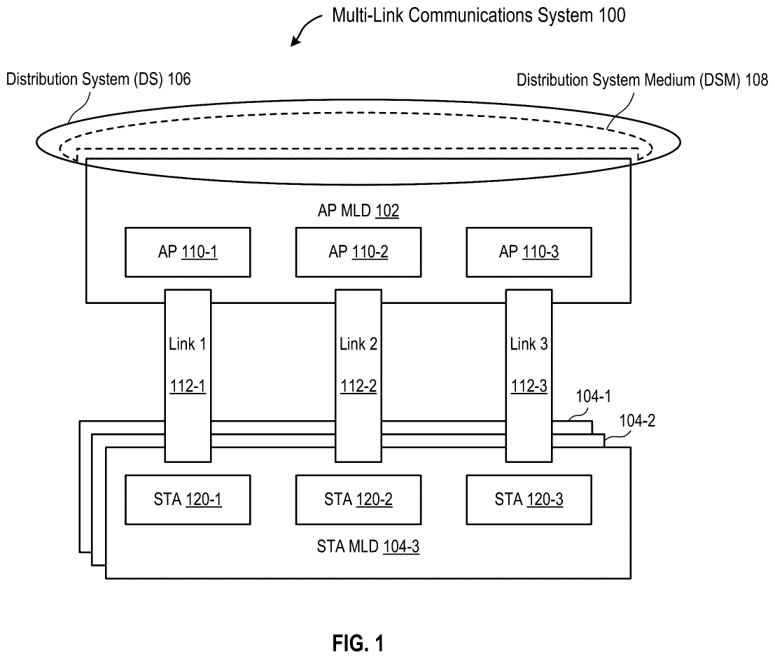

FIG. 1 illustrates an example of a multi-link (ML) communications system 100 in accordance with embodiments of the present disclosure. The illustrated multi-link communications system 100 includes at least one AP multi-link device (MLD) 102, and one or more non-AP multi-link devices, which are, for example, implemented as station (STA) MLDs 104-1, 104-2, 104-3. The multi-link communications system 100 can be used in various applications, such as industrial applications, medical applications, computer applications, and/or consumer or appliance applications. In the illustrated example, the multi-link communications system is a wireless communications system compatible with an IEEE 802.11 standard. Although the depicted multi-link communications system 100 is shown in FIG. 1 with certain components and described with certain functionality herein, other embodiments of the multi-link communications system 100 may include fewer or more components to implement the same, less, or more functionality. For example, although the multi-link communications system 100 is shown in FIG. 1 includes the AP MLD 102 and the STA MLDs 104-1, 104-2, 104-3, in other embodiments, the multi-link communications system includes other multi-link devices, such as, multiple AP MLDs and multiple STA MLDs, multiple AP MLDs and a single STA MLD, a single AP MLD and a single STA MLD. In another example, in some embodiments, the multi-link communications system includes more than three STA MLDs and/or less than three STA MLDs. In yet another example, although the multi-link communications system 100 is shown in FIG. 1 as being connected in a certain topology, the network topology of the multi-link communications system 100 is not limited to the topology shown in FIG. 1.

In the embodiment depicted in FIG. 1, the AP MLD 102 includes multiple radios, implemented as APs 110-1, 110-2, 110-3. In some embodiments, the AP MLD 102 is an AP multi-link logical device or an AP multi-link logical entity (MLLE). In some embodiments, a common part of the AP MLD 102 implements upper layer Media Access Control (MAC) functionalities (e.g., beaconing, association establishment, reordering of frames, etc.) and a link specific part of the AP MLD 102, i.e., the APs 110-1, 110-2, 110-3, implement lower layer MAC functionalities (e.g., backoff, frame transmission, frame reception, etc.). The APs 110-1, 110-2, 110-3 may be implemented in hardware (e.g., circuits), software, firmware, or a combination thereof. At least one of the APs 110-1, 110-2, 110-3 may be fully or partially implemented as an integrated circuit (IC) device. In some embodiments, the AP MLD and its affiliated APs 110-1, 110-2, 110-3 are compatible with at least one WLAN communications standard (e.g., at least one IEEE 802.11 standard). For example, the APs 110-1, 110-2, 110-3 may be wireless APs compatible with at least one at least one IEEE 802.11 standard.

In some embodiments, an AP MLD (e.g., the AP MLD 102) is connected to a local network (e.g., a local area network (LAN)) and/or to a backbone network (e.g., the Internet) through a wired connection and wirelessly connects to wireless STA MLDs, for example, through one or more WLAN communications standards, such as an IEEE 802.11 standard. In some embodiments, an AP (e.g., the AP 110-1, the AP 110-2, and/or the AP 110-3) includes at least one antenna, at least one transceiver operably connected to the at least one antenna, and at least one controller operably connected to the corresponding transceiver. In some embodiments, at least one transceiver includes a physical layer (PHY) device. The at least one controller may be configured to control the at least one transceiver to process received packets through the at least one antenna. The at least one controller may be implemented within a processor, such as a microcontroller, a host processor, a host, a digital signal processor (DSP), or a central processing unit (CPU), which can be integrated in a corresponding transceiver. In an example, each of the APs 110-1, 110-2, 110-3 of the AP MLD 104 operates in different frequency bands. For example, at least one of the APs 110-1, 110-2, 110-3 of the AP MLD 104 operates in a 2.4/5/6 Gigahertz (GHz) frequency band. For example, the AP 110-1 may operate at a 6 Gigahertz (GHz) band (e.g., in a 320 MHz Basic Service Set (BSS) operating channel or other suitable BSS operating channel), the AP 110-2 may operate at 5 GHz band (e.g., a 160 MHz BSS operating channel or other suitable BSS operating channel), and the AP 110-3 may operate at 2.4 GHz band (e.g., a 20 MHz BSS operating channel or other suitable BSS operating channel).

In the illustrated embodiment, the AP MLD is connected to a distribution system (DS) 106 through a distribution system medium (DSM) 108. The distribution system (DS) 106 may be a wired network or a wireless network that is connected to a backbone network such as the Internet. The DSM 108 may be a wired medium (e.g., Ethernet cables, telephone network cables, or fiber optic cables) or a wireless medium (e.g., infrared, broadcast radio, cellular radio, or microwaves). Although the AP MLD 102 is shown in FIG. 1 as including three APs, other embodiments of the AP MLD 102 may include fewer than three APs or more than three APs. In addition, although some examples of the DSM 108 are described, the DSM 108 is not limited to the examples described herein.

In the embodiment depicted in FIG. 1, the STA MLD 104-1 includes radios, which are implemented as multiple non-AP stations (STAs) 120-1, 120-2, 120-3. The STAs 120-1, 120-2, 120-3 may be implemented in hardware (e.g., circuits), software, firmware, or a combination thereof. At least one of the STAs 120-1, 120-2, 120-3 may be fully or partially implemented as an IC device. In some embodiments, the non-AP STAs 120-1, 120-2, 120-3 are part of the STA MLD 104-1, such that the STA MLD may be a communications device that wirelessly connects to an AP MLD, such as, the AP MLD 102. For example, the STA MLD 104-1 (e.g., at least one of the non-AP STAs 120-1, 120-2, 120-3) may be implemented in a laptop, a desktop personal computer (PC), a mobile phone, or other communications device that supports at least one WLAN communications standard. In some embodiments, the STA MLD and its affiliated STAs 120-1, 120-2, 120-3 are compatible with at least one IEEE 802.11 standard. In an example, each of the non-AP STAs 120-1, 120-2, 120-3 includes at least one antenna, at least one transceiver operably connected to the at least one antenna, and at least one controller connected to the corresponding transceiver. The at least one transceiver may include a PHY device. The at least one controller can be configured to control the at least one transceiver to process received packets through the at least one antenna. In some embodiments, the at least one controller is implemented by a processor, such as a microcontroller, a host processor, a host, a DSP, or a CPU, which can be integrated in a corresponding transceiver. In an example, the STA MLD has one MAC data service interface. In another example, a single address is associated with the MAC data service interface and is used to communicate on the DSM 108. In some embodiments, the STA MLD 104-1 implements a common MAC data service interface and the non-AP STAs 120-1, 120-2, 120-3 implement a lower layer MAC data service interface.

In an example, the AP MLD 102 and/or the STA MLDs 104-1, 104-2, 104-3 identify which communications links support the multi-link operation during a multi-link operation setup phase and/or exchanges information regarding multi-link capabilities during the multi-link operation setup phase. Each of the STAs 120-1, 120-2, 120-3 of the STA MLD may operate in a different frequency band. For example, at least one of the STAs 120-1, 120-2, 120-3 of the STA MLD 104-1 operates in the 2.4/5/6 GHz frequency band. For example, the STA 120-1 may operate at 6 GHz band (e.g., in a 320 MHz BSS operating channel or other suitable BSS operating channel), the STA 120-2 may operate at 5 GHz band (e.g., a 160 MHZ BSS operating channel or other suitable BSS operating channel), and the STA 120-3 may operate at 2.4 GHz band (e.g., a 20 MHz BSS operating channel or other suitable BSS operating channel). Although the STA MLD 104-1 is shown in FIG. 1 as including three non-AP STAs, other embodiments of the STA MLD 104-1 may include fewer than three non-AP STAs or more than three non-AP STAs.

Each of the MLDs 104-2, 104-3 may be the same as or similar to the MLD 104-1. For example, the MLD 104-2 or 104-3 includes one or multiple non-AP STAs. In some embodiments, each of the non-AP STAs includes at least one antenna, at least one transceiver operably connected to the at least one antenna, and at least one controller connected to the corresponding transceiver. In some embodiments, the at least one transceiver includes a PHY device. The at least one controller can be configured to control the at least one transceiver to process received packets through the at least one antenna. In some embodiments, the at least one controller is implemented by a processor, such as a microcontroller, a host processor, a host, a DSP, or a CPU, which can be integrated in a corresponding transceiver.

In the illustrated network, the STA MLD 104-1 communicates with the AP MLD 102 through multiple communications links 112-1, 112-2, 112-3. For example, each of the STAs 120-1, 120-2, 120-3 communicates with an AP 110-1, 110-2, or 110-3 through a corresponding wireless communications link 112-1, 112-2, or 112-3. Although the AP MLD 102 communicates (e.g., wirelessly communicates) with the STA MLD 104-1 through multiple links 112-1, 112-2, 112-3, in other embodiments, the AP MLD 102 may communicate (e.g., wirelessly communicate) with the STA MLD through more than three communications links or less three than communications links. In some embodiments, the communications links in the multi-link communications system are wireless communications links, which may include one or more 2.4/5/6/45/60 GHz links.

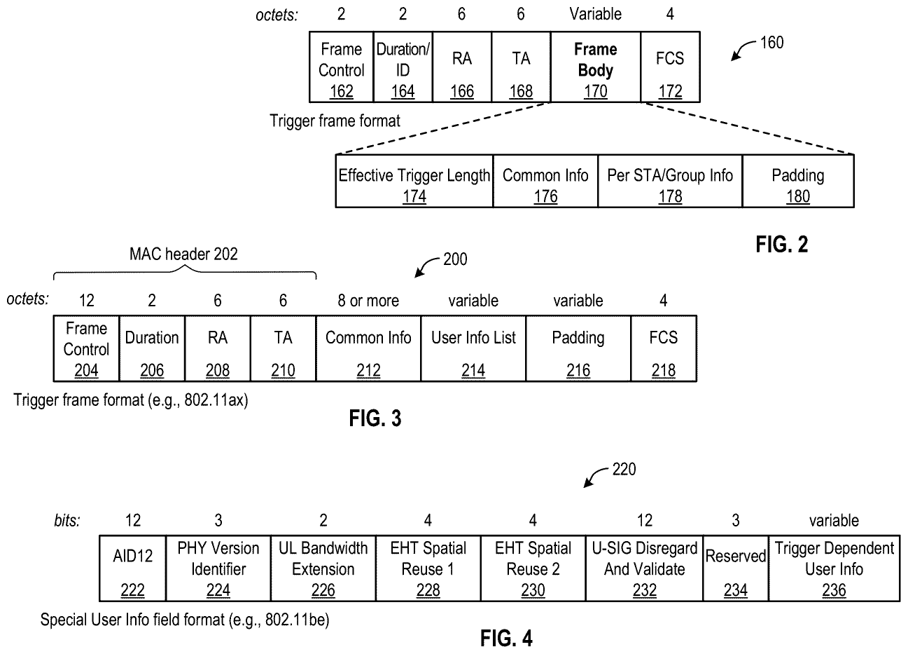

FIGS. 2-5 are provided to show the evolution of an 802.11 trigger frame format over time. Referring first to FIG. 2, an example of an early trigger frame format that may be used in accordance with embodiments of the present disclosure is illustrated. In this example, the trigger frame 160 is a MAC control frame included in a physical layer data unit transmitted by an access point (e.g., an AP affiliated with an AP MLD 102) to a plurality of client stations. The illustrated trigger frame 160 includes a plurality of fields, including a frame control field 162, a duration/ID field 164, a first address field (e.g., a receiver address (RA) field) 166, a second address field (e.g., a transmitter address (TA) field) 168, a frame body field 170 and a frame check sequence (FCS) field 172. The number of octets of bits allocated to each field of the trigger frame 160, according to this example, is indicated in FIG. 2 above the corresponding field. In an example, the frame control field 162 (and frame control field 204 of FIG. 3) includes a plurality of subfields including Protocol Version, Type, Subtype, To DS, From DS, More Fragments, Retry, Power Management, More Data, Protected Frame, and Order subfields. The type subfield indicates that the frame is a control frame and the subtype subfield indicates a subtype (e.g., trigger type) of the frame. In an embodiment, the frame control field 162, the duration/ID field 164, the first address field (e.g., a receiver address (RA) field) 166, and the second address field (e.g., a transmitter address (TA) field) 168 comprise a MAC header of the trigger frame 160. In an example, the frame body field 170 and the FCS field 172 comprise an MSDU portion of the trigger frame 160.

In the trigger frame format of FIG. 2, the frame body field 170 includes an effective trigger length indicator 174, a Common Information field 176, one or more per-STA/group fields 178 and a padding field 180. In an example, the effective trigger length indicator 174 indicates a length or duration corresponding to the length or duration of the Common Information field 176 and the one or more per-STA/group fields 178. Examples of determining a length of a padding field are described with reference to padding field 216 of FIG. 3.

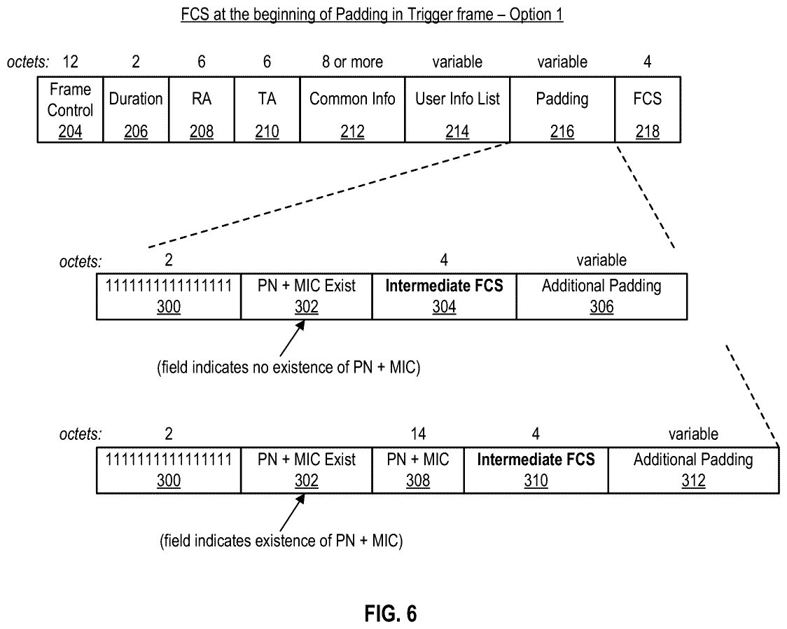

FIG. 3 depicts another example of a trigger frame format that may be used in accordance with embodiments of the present disclosure. The trigger frame 200 of this embodiment corresponds to the trigger frame format introduced in IEEE 802.11ax, and may include additional fields and capabilities as specified in IEEE 802.11be (e.g., the Special User Information (“Special User Info”) field 220 of FIG. 4) and future amendments to the IEEE 802.11 standard, including IEEE 802.11bn. For example, the trigger frame 200 can include one or more of the embodiments of the present disclosure described below with reference to FIGS. 6-21. The trigger frame 200 may be used to solicit TB PPDUs (including legacy and non-legacy TB PPDUs) from one or more STAs.

In an example, the trigger frame 200 is a MAC control frame included in a PPDU transmitted by an access point (e.g., AP MLD 102) to one station or a plurality of client stations, and includes resource unit allocation indications and other transmission parameters to be used for transmission of an uplink OFDMA or UL MU MIMO data unit during a transmit opportunity (TXOP). For example, the trigger frame 200 may be included in a PPDU that conforms with the IEEE 802.11bn, 802.11be, 802.11ax or other amendment to the IEEE 802.11 standard. In some examples, the trigger frame 200 can be used by a non-AP STA to solicit a non-TB PPDU(s) carrying various control information (e.g., available and unavailable times) in a control frame.

The illustrated trigger frame 200 includes a MAC header 202, a Common Information (“Common Info”) field 212, a User Information (“User Info”) list field 214, a padding field 216 having zero or more padding bits, and a frame check sequence (FCS) field 218. The MAC header 202 includes a frame control field 204, a duration field 206, a receiver address (RA) field 208, and a transmitter address (TA) field 210. The Common Info field 212 and User Info list field 214 carry configuration information which may be used by a receiving device to configure a TB PPDU that is transmitted in response to receiving a trigger frame 200. For example, the User Info list field 214 may include one or more User Information (“User Info”) fields, each of which carries per-user information for a respective user, while the Common Info field 212 may carry information that is common to all recipients (e.g., any users associated with the User Info fields of the User Info list field 214) of the trigger frame 200.

In an example, the (legacy) FCS field 218 is a 32-bit field containing a 32-bit CRC value. The FCS is calculated over all the fields (i.e., “calculation fields”) of the MAC header and the frame body fields. The FCS value may be calculated and appended to a trigger frame by an AP prior to transmission. Upon receipt of the trigger frame by a client device, the client device can calculate an FCS value for the frame and compare it with the FCS value calculated by the AP. If the two FCS values match, it is assumed that the frame was not corrupted during transmission. If the two FCS values are different, an error is assumed and the frame is discarded.

The padding field 216 is optionally present in trigger frame 200 to extend the frame length for the following purposes: (1) to give the recipient STAs enough time to prepare a response for transmission an SIFS after the frame is received and (2) to align the end time of simultaneously transmitted PPDUs. In an example, the padding field, if present, is at least two octets in length and is set to all Is. In this example, the length of the padding field can be determined as described below.

In an example, client stations (e.g., a STA affiliated with a STA MLD 104) provide, to an access point (e.g., an AP affiliated with an AP MLD 102) indications of a time duration required by the client stations to prepare an uplink transmission upon receiving a trigger frame. For example, the client stations provide to the AP respective indications of an additional time duration before the end of the PPDU that includes a trigger frame for the transmission by the client station of an uplink data unit following a SIFS after the PPDU carrying the trigger frame. Based on time duration requirements received from client stations being triggered by a trigger frame, the AP determines whether padding is needed to provide sufficient time for the client stations to prepare the uplink transmission triggered by the trigger frame.

In an example, a client station provides its time duration requirements to the AP by transmitting a management frame to the AP, wherein the management frame includes a capabilities element such as an EHT (or HE, UHR, etc.) capabilities field. In this example, the EHT capabilities field includes a trigger frame (TF) MAC padding duration capability indication. The TF MAC padding duration capability indication is set to indicate one of zero (0) microseconds (μs), eight (8) μs or sixteen (16) μs. In an example, when the AP is to transmit a trigger frame to one station or a group of client stations, the AP determines a number of padding bits to be included in a padding portion (e.g., padding field 216) of the trigger frame based at least in part on TF MAC padding duration capability indications received from the client station(s) in the group. More specifically, in an embodiment, the AP determines a number of padding bits to be included in the padding portion the trigger frame based on a longest value of the TF MAC padding duration capability indications received from the client stations in the group, such that a duration of the padding portion is equal to or greater than the longest value of the TF MAC padding duration capability indications (e.g., 8 μs or 16 μs) received from the client stations in the group. In an example, the AP then adds the padding portion to the trigger frame. In some embodiments, the padding portion results in one or more additional OFDM symbols in the trigger frame. As an example, a padding portion corresponding to the duration of 16 μs being transmitted in a PDDU that conforms to the IEEE 802.11ax amendment results in at least one additional OFDM symbol in the trigger frame. In another example, the AP determines a number of padding bits to be included in the padding portion of the trigger frame based on the value of the TF MAC padding duration capability indications received from each client station in the group, such that for each client a duration of the padding portion plus the User Info field(s) after the User Info field for the client is equal to or greater than the value of the TF MAC padding duration capability indications (e.g., 8 μs or 16 μs) received from the client station.

In an example, the length of a padding field for a trigger frame can be determined to satisfy rules as specified at section 26.5.2.2.3 of the IEEE 802.11ax amendment to the IEEE 802.11 standard. As set forth therein:

An AP transmitting a PPDU that contains a BCC-encoded triggering frame soliciting a response from a non-AP STA shall ensure that the number of bits in the PSDU following the last bit of SCH is at least L_{PAD,MAC} as defined in Equation (26-1), which is based on the MinTrigProcTime indicated by the non-AP STA (see Table 9-322a), where SCH is either
The User Info field addressed to the STA of the last or only Trigger frame, or
The last TRS Control subfield in the PSDU.

L_{PAD,MAC}=N_{DBPS}m_{PAD} (26-1)
where
N_{DBPS} is defined in Table 17-4 for a non-HT PPDU, Table 19-7 for an HT PPDU, Table 21-6 for a VHT PPDU, and Table 27-15 for an HE PPDU. If the triggering frame is carried in an HE MU PPDU, N_{DBPS} is replaced by N_{DBPS,u} of the target user in Equation (26-1).

m_{PAD} is as follows:
For a non-HT PPDU, HT PPDU, and VHT PPDU:

$${m}_{PAD} = \{ \begin{matrix}0 , if MinTrigProcTime is 0 \\ 2 , if MinTrigProcTime is 8 μs \\ 4 , if MinTrigProcTime is 16 μs\end{matrix}$$

For an HE PPDU:

$${m}_{PAD} = \{ \begin{matrix}0 , if MinTrigProcTime is 0 \\ 1 , if MinTrigProcTime is 8 or 16 μs\end{matrix}$$

An AP transmitting a Trigger frame that contains at least one User Info field with AID12 subfield indicating allocation of one or more contiguous RA-RUs for associated STAs shall ensure that the number of bits following the last bit of SCH is at least L_{PAD,MAC} as defined in Equation (26-1), which is based on the largest MinTrigProcTime of all associated non-AP STAs, where SCH is the last User Info field with AID12 subfield equal to either 1 or 2046.

An AP transmitting a Trigger frame that contains at least one User Info field with AID12 subfield indicating allocation of one or more contiguous RA-Rus for unassociated non-AP STAs should ensure that the number of bits following the last bit of SCH is at least 4×N_{DBPS} for a non-HT PPDU, HT PPDU or VHT PPDU or N_{DBPS} for an HE PPDU, where SCH is the last User Info field with AID 12 subfield equal to either 2045 or 2046.

An AP transmitting an NFRP Trigger frame shall ensure that the number of bits following the last User Info field with an AID12 subfield not equal to 4095 is at least 4×N_{DBPS} for a non-HT PPDU, HT PPDU or VHT PPDU or N_{DBPS} for an HE PPDU.

An AP may use any type of padding to satisfy the MinTrigProcTime requirement of a non-AP STA, such as using the Padding field in a Trigger frame, using post-EOF A-MPDU padding, or aggregating other MPDUs in the A-MPDU.

If the triggering frame is LDPC encoded, then the transmitting AP ensures that T_{TrigProc} meets the following requirements:
T_{TrigProc} shall be greater than or equal to the MinTrigProcTime specified by the non-AP STAs that are the recipients of the Trigger frame.
For a Trigger frame that contains at least one User Info field with AID12 subfield indicating allocation of one or more contiguous RA-RUs for associated STAs, T_{TrigProc} shall be greater than or equal to the MinTrigProcTime of all associated non-AP STAs.
For a Trigger frame that contains at least one User Info field with AID12 subfield indicating allocation of one or more contiguous RA-RUs for unassociated STAs, T_{TrigProc} should be at least 16 μs.
For an NFRP Trigger frame, T_{TrigProc} shall be at least 16 μs.
T_{TrigProc} is defined as the duration of PPDU that is after the OFDM symbol containing the last coded bit of the LDPC codeword that encodes the last bit of SCH minus T_{PE,nominal} defined in 27.3.13.

FIG. 4 depicts an example of a Special User Info field format of a trigger frame that may be used in various embodiments of the present disclosure. The Special User Info field, introduced in 802.11be, is a User Info field that does not carry user specific information for an addressed STA but carries extended common information not provided in the Common Info field. The Special User Info field is identified by an AID12 value of 2007 and is optionally present in a trigger frame that is generated by an EHT AP. When present, the Special User Info field is located immediately after the Common Info field of the trigger frame, is generally of the same length as a User Info field, and carries information for the U-SIG field of a solicited EHT TB PPDU.

The existence of the Special User Info field in the trigger frame 200 is indicated by the Special User Info field flag subfield (B55) of the EHT variant of the Common Info field in the trigger frame. In particular, B55 is set to 1 to indicate that there is no Special User Info field in the trigger frame, and is set to 0 to indicate that the Special User Info field exists in the trigger frame immediately after the Common Info field.

The illustrated Special User Info field includes an AID12 subfield 222 consisting of 12 bits, a PHY Version Identifier subfield 224 consisting of 3 bits, a UL Bandwidth Extension subfield 226 consisting of 2 bits, an EHT Spatial Reuse 1 subfield 228 consisting of 4 bits, an EHT Spatial Reuse 2 subfield 230 consisting of 4 bits, a U-SIG Disregard And Validate subfield 232 consisting of 12 bits, a Reserved subfield 234 consisting of 3 bits, and a Trigger Dependent User Info subfield 236 of variable length. The PHY Version Identifier subfield 224 indicates the PHY version of the solicited TB PPDU that is not an HE TB PPDU. The PHY Version Identifier subfield is set to 0 for EHT, and may be set to another value to indicate UHR.

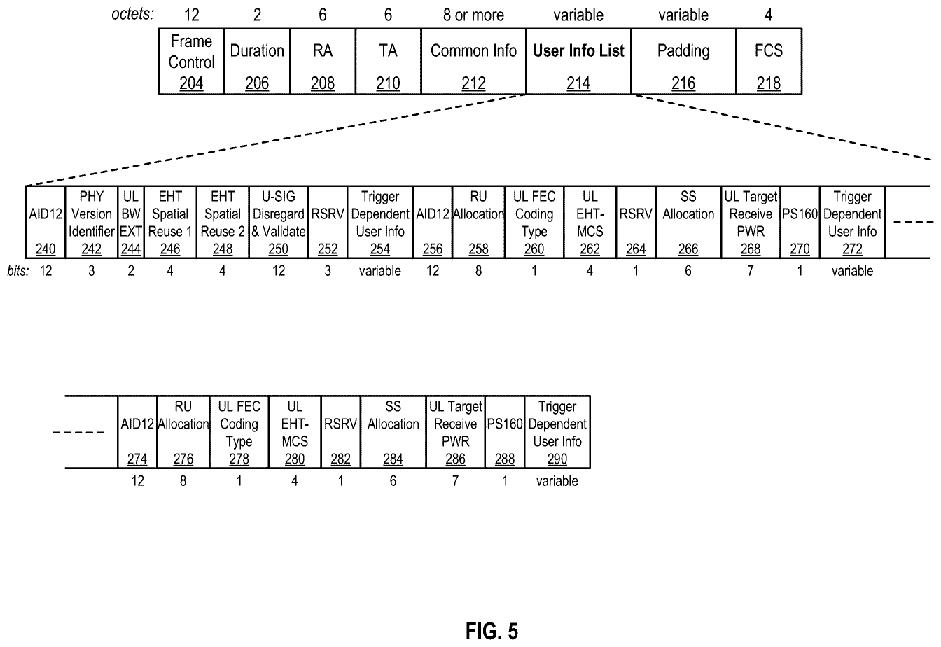

FIG. 5 depicts an example of a User Info List field 214 of a trigger frame that may be used in various embodiments of the present disclosure. In the illustrated example, the User Info List field 214 includes a Special User Info field followed by a plurality of User Info fields. In this example, the Special User Info field has the various subfields described with reference to FIG. 4, and the User Info fields are EHT variant User Info fields as specified in IEEE 802.11be. As specified in IEEE 802.11.be, all User Info fields (including the Special User Info field) in the User Info List field of a trigger frame have the same length unless the trigger frame is an MU-BAR trigger frame. In the illustrated example, the frame control field 204, duration field 206, receiver address (RA) field 208, transmitter address (TA) field 210, Common Info field 212, User Info list field 214, padding field 216, and frame check sequence (FCS) field 218 correspond to the fields of trigger frame 200 described with reference to FIG. 3. In addition, the AID12 subfield 240, a PHY Version Identifier subfield 242, UL Bandwidth Extension subfield 244, an EHT Spatial Reuse 1 subfield 246, EHT Spatial Reuse 2 subfield 248, U-SIG Disregard And Validate subfield 250, Reserved subfield 252, and Trigger Dependent User Info subfield 254 correspond to the fields of the Special User Info field 220 of FIG. 4.

Each User Info field is associated with a respective AID value. The AID value may be a 12-bit value carried in the AID12 subfield (in bit positions B0-B11) of a User Info field. In an example, the AID value may uniquely identify a particular STA (or user) in a BSS. Each STA may be assigned a unique AID value, for example, upon associating with the BSS. As noted, a Special User Info field can be identified by an AID12 value of 2007.

The first User Info field includes an AID12 subfield 256 consisting of 12 bits, an RU allocation subfield 258 consisting of 8 bits, a UL FEC Coding Type subfield 260 consisting of 1 bit, a UL EHT-MCS subfield 262 consisting of 4 bits, a reserved bit 264, an SS Allocation subfield 266 consisting of 6 bits, a UL Target Receive Power subfield 268 consisting of 7 bits, a PS160 subfield 270 consisting of 1 bit, and a Trigger Dependent User Info subfield 272 of variable length. Likewise, the last User Info field of the illustrated User Info List field 214 includes an AID12 subfield 274, an RU allocation subfield 276, a UL FEC Coding Type subfield 278, a UL EHT-MCS subfield 280, a reserved bit 282, an SS Allocation subfield 284, a UL Target Receive Power subfield 286, a PS160 subfield 288, and a Trigger Dependent User Info subfield 290. Additional (or modified) subfields may be included in the IEEE 802.11bn amendment to accommodate new features and capabilities while maintaining backwards compatibility with earlier version of the 802.11 standard.

Various innovative trigger frame formats and methods are described below for generating an IEEE 802.11bn trigger frame. In various examples, a trigger frame with an intermediate FCS(s) is constructed such that the location of an intermediate FCS value within the trigger frame can be determined by a recipient client device without modifying dedicated legacy fields (e.g., HE and EHT fields), adding new fields/subfields, or utilizing a limited number of reserved bits that may be needed to implement other features of IEEE 802.11bn. In an example, a trigger frame with an intermediate FCS field can be defined to solicit an EHT TB PPDU and/or a UHR TB PPDU. In an example, the trigger frame with an intermediate FCS field can be defined to solicit a UHR TB PPDU via the PHY Version Identifier subfield of the Special User Info field, thereby avoiding the need to define a new Trigger Type when combined with one or more of the trigger frame formats of the present disclosure.

Referring now to FIG. 6, an example of a trigger frame padding field 216 including an intermediate FCS value and PN+MIC Exist field in accordance with embodiments of the present disclosure is shown. In the illustrated examples, the trigger frame includes an intermediate FCS value 304 or FCS value 310 (e.g., 4 octets) in addition to the legacy FCS field 218. In this example, the FCS field 218 is included to provide backward compatibility for communications with client devices that do not support non-legacy features that require intermediate FCS checking (e.g., IEEE 802.11ax STAs, 802.11be STAs, and UHR STAs that do not support the features that require intermediate FCS checking). In various of the embodiments described herein, the intermediate FCS value is calculated over the preceding fields of a trigger frame that are intended for reception by one or more UHR STAs. In other embodiments, intermediate FCS values may be calculated for one or more User Info fields and/or Special User Info fields. By including a separate intermediate FCS value(s) in a trigger frame, a recipient UHR STA may advantageously utilize it as a signal to stop decoding the trigger frame (e.g., ignore any trailing padding bits and the conventional FCS value) if the recipient UHR implements certain features (e.g., a low capability mode, dynamic subband switching, etc.) that allow the recipient UHR to stop decoding a trigger frame after checking an intermediate FCS field.

In the illustrated examples of FIG. 6, the PN+MIC Exist field 302 and intermediate FCS value 304/310 follow the first 16 bits of the padding field 216. The first 16 bits of the padding field 216 are all set to 1 in these examples, as the 802.11be amendment specifies that a padding field, if present in a trigger frame, is a field with all padding bits set to 1, has a length of at least two octets, and is located between the User Info List field and the FCS field.

The PN+MIC Exist field 302 (e.g., 1 or 2 bits) indicates the existence of a packet number (PN) and message integrity check (MIC) value (“PN+MIC value”) 308 in the trigger frame. A PN+MIC field is included in protected frames to provide security parameters (e.g., a frame counter value) and is designed to prevent packet eavesdropping and spoofing, such as “man in the middle” attacks. Under the condition that some STAs addressed by a trigger frame support a protected trigger frame while other STAs addressed by a trigger frame do not support a protected trigger frame, an STA needs to know the location of the intermediate FCS value and the PN+MIC value.

In the illustrated examples, the PN+MIC Exist field 302 immediately follows the first 16 bits 300 of the padding field 216. If the PN+MIC Exist field 302 indicates that a PN+MIC field is not included in the trigger frame, the intermediate FCS value 304 immediately follows PN+MIC Exist field 302. The additional padding 306 includes the (remaining) padding bits for all STAs being addressed by the trigger frame, and begins at the end of the intermediate FCS value 304. In contrast, if the PN+MIC Exist field 302 is set to indicate that the trigger frame includes PN+MIC field 308, the PN+MIC field 308 immediately follows the PN+MIC Exist field 302, and the intermediate FCS value 310 immediately follows the PN+MIC field 308. In this example, additional padding 312 follows the intermediate FCS value 310. In some embodiments, the PN+MIC Exist field can be a repurposed reserved bit of a User Info field.

In a further example, an intermediate FCS value is always included in a trigger frame when at least one addressed client enables a feature that needs to discontinue decoding of a trigger frame prior to the end of the trigger frame. In an example, an addressed client can determine whether an intermediate FCS value exists based on whether it enables the feature requiring an early end to the decoding of a trigger frame. In another example, a trigger frame explicitly indicates whether it includes an intermediate FCS value (e.g., by repurposing a reserved bit of a Common Info field or by adding another field, such as an Intermediate FCS Exist field, before the PN+MIC Exist field 302.

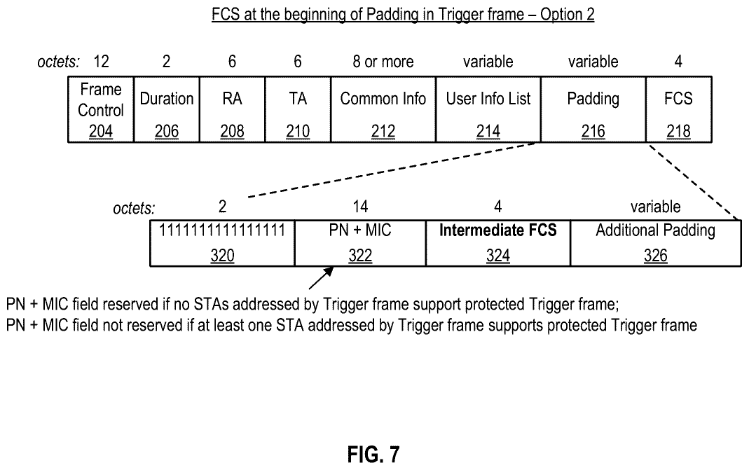

FIG. 7 illustrates another example of a trigger frame padding field 216 including an intermediate FCS value 324 and PN+MIC field 322 in accordance with embodiments of the present disclosure. In this example, the PN+MIC field 322 (e.g., 14 octets) and the intermediate FCS value 324 (e.g., 4 octets) are at fixed locations following the first 16 bits 320 of the padding field 216. In the illustrated example, the PN+MIC field 322 immediately follows the first 16 bits 320 of the padding field 216, the intermediate FCS field 324 immediately follows the PN+MIC field 322 and is followed by Additional Padding 326.

In an example, when no STAs addressed by the trigger frame support protected trigger frames, the PN+MIC field 322 field is reserved (e.g., not used). If some or all of the STAs addressed by the trigger frame support protected trigger frames, the PN+MIC field 322 field is not reserved. In a further example, if no addressed STA enables a feature that requires an early end to decoding of a trigger frame, the intermediate FCS field is reserved. In another example, the PN+MIC field 322 and the intermediate FCS field 324 are reversed.

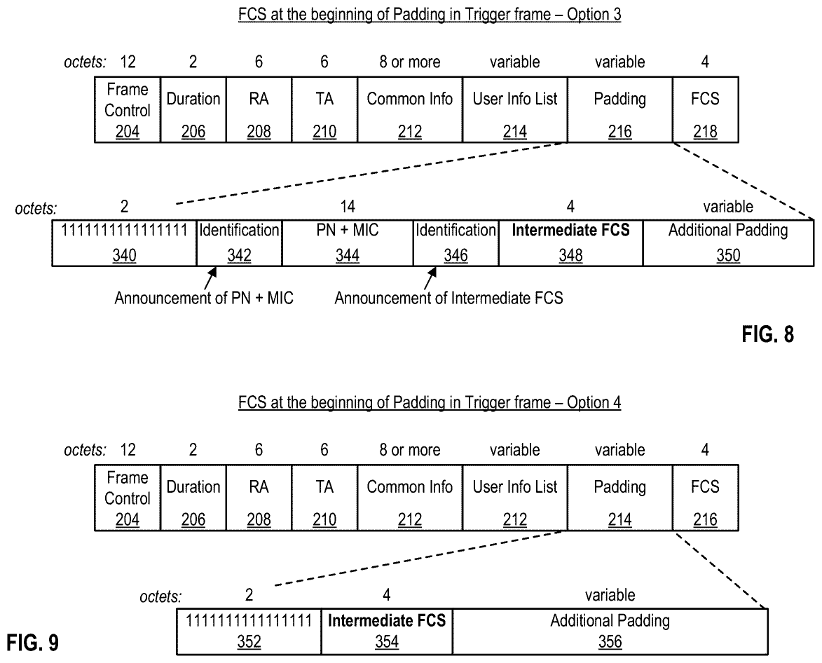

FIG. 8 illustrates another example of a trigger frame padding field 216 including an intermediate FCS value 348, a PN+MIC field 344, and identification fields 342 and 346 in accordance with embodiments of the present disclosure. In the illustrated trigger frame, the presence of a PN+MIC field and intermediate FCS field are announced by separate identification fields.

In this example, a first identification field 342 follows the first 16 bits 340 of the padding field 216, and announces the presence of a PN+MIC field 344. If the PN+MIC field 344 is present as indicated by the identification field 342, it immediately follows the identification field 342. If the PN+MIC field 344 is not present, its (e.g., 8 octet) field may be reserved or omitted. A separate identification field 346 follows the PN+MIC field 344 (or identification field 346 if the PN+MIC field 344 is not present), and indicates the presence of an intermediate FCS field 348. The intermediate FCS field 348, if present, is followed by additional padding 350.

FIG. 9 illustrates another example of a trigger frame padding field 216 including an intermediate FCS value in accordance with embodiments of the present disclosure. In this example, an intermediate FCS field (e.g., 4 octets) follows the first 16 bits 352 of the padding field 216 of the trigger frame. Additional padding 356 follows the intermediate FCS field 354 to fulfil the padding requirements of the trigger frame. In an example, the intermediate FCS field 354 is included in a trigger frame when at least one recipient of the trigger frame enables a feature that requires an early end to decoding of the trigger frame.

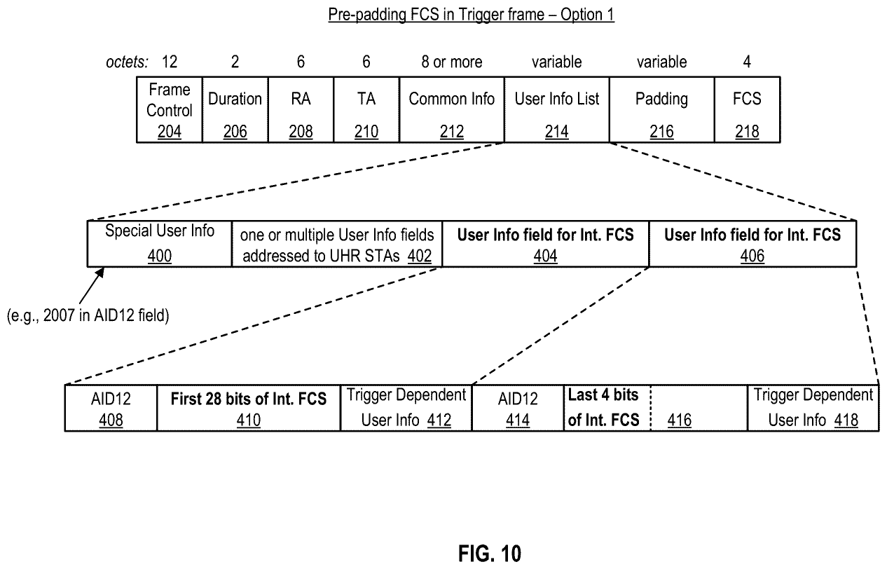

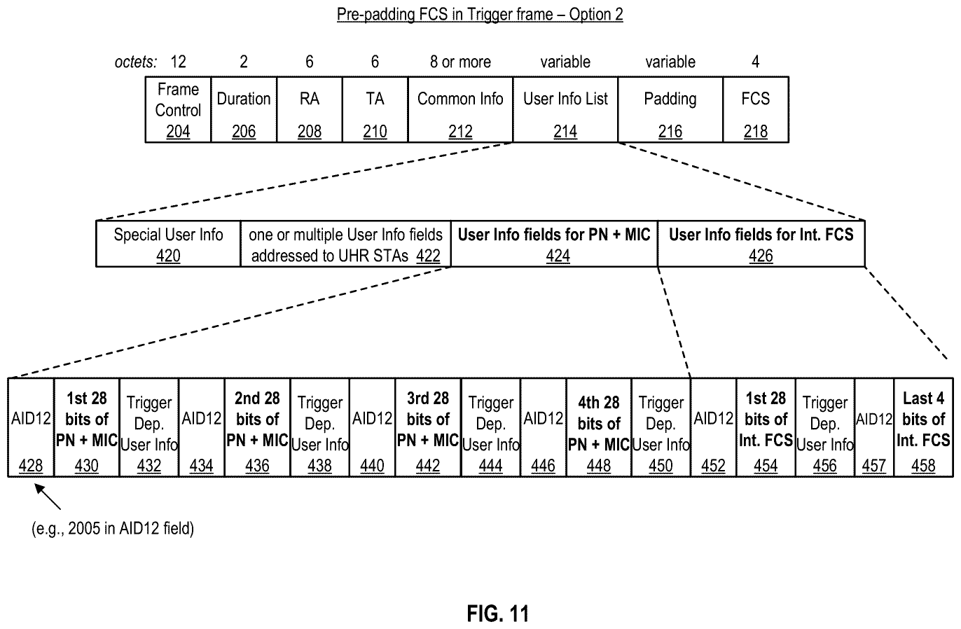

FIG. 10 illustrates an example of a User Info List field 214 including an intermediate FCS value in accordance with embodiments of the present disclosure. In this example, the intermediate FCS value is carried in two User Info fields: User Info field for intermediate FCS 404 and User Info field for intermediate FCS 406 (which may also be individually referred to as an “Intermediate FCS User Info field” or “User Info field for Intermediate FCS”). The two Intermediate FCS User Info fields may be the last two User Info fields of the User Info List field 214 (e.g., preceding the Padding field 216 when padding is required) with a special value in their respective AID12 fields. In an example, the special value may be a value (or range of values) greater than 2007. In the illustrated example, trigger frame protection is not required and a PN+MIC field is not included in the trigger frame. In other examples described below, a PN+MIC field is carried in additional User Info fields. The intermediate FCS value of this example may be calculated over the preceding fields of the trigger frame, and a recipient UHR STA may stop decoding the trigger frame following the intermediate FCS value.

The Special User Info field 400 is distinguished from a User Info field by a special AID12 value (e.g., 2007). In an example, the Special User Info field 400 includes a PHY Version Identifier subfield 240 value that can be set to identify a trigger frame as an EHT variant trigger frame or UHR variant trigger frame. In the illustrated example, User Info field for intermediate FCS 404 and User Info field for intermediate FCS 406 may also be identified by a special AID 12 value (e.g., 2006 or 2008). In this example, the special AID12 value is the same for both User Info fields carrying the intermediate FCS. Continuing with this example, User Info field for Intermediate FCS 404 and 406 have the same length as the Special User Info field 400, and the Trigger Dependent User Info fields 412 and 416 are reserved.

In the illustrated example, the Special User Info field 400 is followed by one or multiple User Info fields 402 addressed to UHR STAs (and, in some examples, EHT/HE STAs). In this example, the User Info field for intermediate FCS 404 carries the first 28 bits of the intermediate FCS value in subfield 410, which follows the 12 bit AID12 subfield 408 and precedes the Trigger Dependent User Info subfield 412. The User Info field for intermediate FCS 406 carries the last 4 bits of the intermediate FCS value in subfield 416, which follows the AID12 subfield 414 and precedes Trigger Dependent User Info subfield 418. In an example, the remaining bits (e.g., 36 bits) of subfield 416 are reserved.

In an example, the Trigger Dependent User Info subfields 412 and 418 follow the same rules as the Trigger Dependent User Info subfield 236 of the Special User Info field 400. In addition, a User Info field carrying an intermediate FCS value (e.g., “Special User Info For FCS field” or “FCS Special User Info field”) may have the same length as the Special User Info field 400 (which may be renamed as “Special User Info for Common Info field”).

FIG. 11 illustrates an example of a User Info List field 214 including an intermediate FCS value and PN+MIC value in accordance with embodiments of the present disclosure. In this example, the trigger frame is a protected frame in which the User Info List field 214 includes a Special User Info field 420, one or multiple User Info fields addressed to UHR STAs 422 (in addition to EHT/HE STAs in some examples), User Info fields 424 for carrying a PN+MIC value, and User Info fields 426 for carrying the (pre-padding) intermediate FCS value. The respective User Info fields of User Info fields for PN+MIC 424 and the User Info fields of User Info fields for Intermediate FCS 426 may have the same length as the Special User Info field 420.

In the illustrated example, a PN+MIC value (e.g., 48+64 bits) is carried in four consecutive User Info fields. The first User Info field includes an AID12 subfield 428, the first 28 bits of the PN+MIC value 430, and a Trigger Dependent User Info subfield 432. The second User Info field includes an AID12 subfield 434, the second 28 bits of the PN+MIC value 436, and a Trigger Dependent User Info subfield 438. The third User Info field includes an AID12 subfield 440, the third 28 bits of the PN+MIC value 442, and a Trigger Dependent User Info subfield 444. The fourth User Info field includes an AID12 subfield 446, the fourth 28 bits of the PN+MIC value 448, and a Trigger Dependent User Info subfield 450. In an example, the AID12 subfields 428, 434, 440 and 450 may be set to a special AID value (e.g., 2005, 2009) that identifies a User Info field which carries part of a PN+MIC value.

In this example, the intermediate FCS value is carried in the last two User Info fields (which may also be individually referred to as an “Intermediate FCS User Info field” or “User Info field for Intermediate FCS”) of the User Info List field 214, such as described above with reference to FIG. 10. As illustrated, the first Intermediate FCS User Info field includes an AID12 subfield 452, the first 28 bits of the intermediate FCS value 454, and a Trigger Dependent User Info subfield 456. The second Intermediate FCS User Info field includes an AID 12 subfield 457, the last 4 bits of the intermediate FCS value 458, and a Trigger Dependent User Info subfield (not separately illustrated).

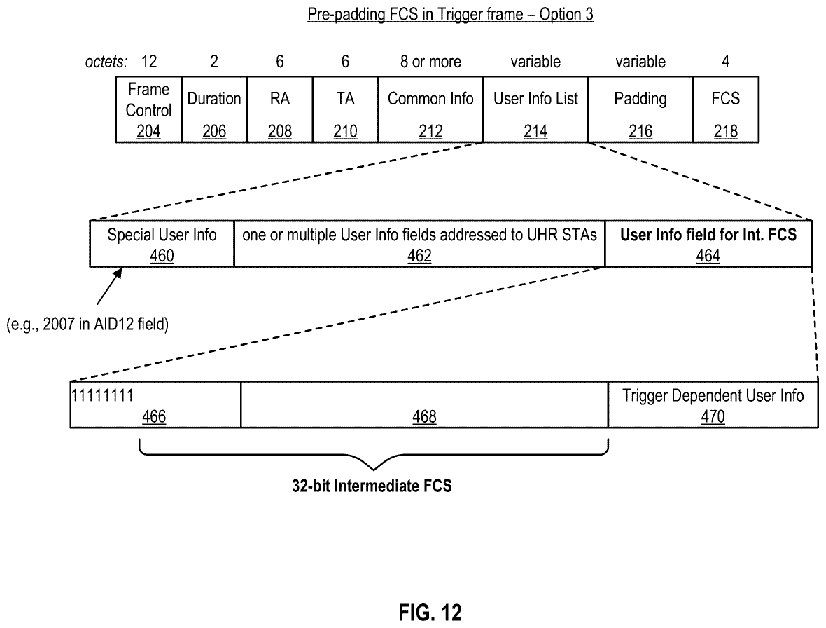

FIG. 12 illustrates another example of a User Info List field 214 including an intermediate FCS value in accordance with embodiments of the present disclosure. In this example, the intermediate FCS value is included in the last User Info field of the User Info list field 214. The User Info list field 214 includes a Special User Info field 460 (e.g., including an indication that the trigger frame is an HE variant trigger frame, EHT variant trigger frame, or UHR variant trigger frame), one or multiple User Info fields addressed to UHR STAs 462 (in some examples, EHT/HE STAs may also be addressed), and a User Info field 464 (e.g., an “Intermediate FCS User Info field” or “User Info field for Intermediate FCS”) including an intermediate FCS value. In an example, the intermediate FCS value is calculated over the preceding fields of the trigger frame, and a UHR STA receiving the trigger frame may stop decoding the trigger frame after the User Info field 464.

In the illustrated example, the User Info field 464 includes an AID12 subfield 466 in which the first 8 bits are set to all Is and the remaining 4 bits are the first four bits of the intermediate FCS value. The next 28 bits 468 of the User Info field 464 carry the remaining 28 bits of the intermediate FCS value and are followed by the Trigger Dependent User Info subfield 470 (which may be omitted in some embodiments). In an example that includes the Trigger Dependent User Info subfield 470, the Trigger Dependent User Info subfield 470 follows the same rules as the Trigger Dependent User Info subfield 236 of the Special User Info field 400. In another example, the trigger frame is a protected trigger frame, and an PN+MIC field is included in four User Info fields that precede the User Info field 464. In another example of the AID12 subfield 466, the bits which do not carry a portion of the intermediate FCS value are allocated to the value n such that the AID n*256+255 with n≥0 and <8 are not allocated to any associated STAs. With such restriction, any associated STA that receives the trigger frame will not treat the (Intermediate FCS) User Info field 464 as a User Info field specifically addressed to it. In yet another example, the User Info field 464 includes an AID12 subfield 466 in which the first 8 bits are set to a value other than all Is (e.g., a value of 254) and the remaining 4 bits are the first four bits of the intermediate FCS value. The next 28 bits 468 of the User Info field 464 carry the remaining 28 bits of the intermediate FCS value and are followed by the Trigger Dependent User Info subfield 470. In an example of the AID12 subfield 466, the bits which do not carry a portion of the intermediate FCS value are allocated to the value n such that the AID n*256+254 with n≥0 and <8 are not allocated to any associated STAs. In any of the foregoing examples, a 32 bit intermediate FCS value can thus be included in the first 40 bits of a single User Info field.

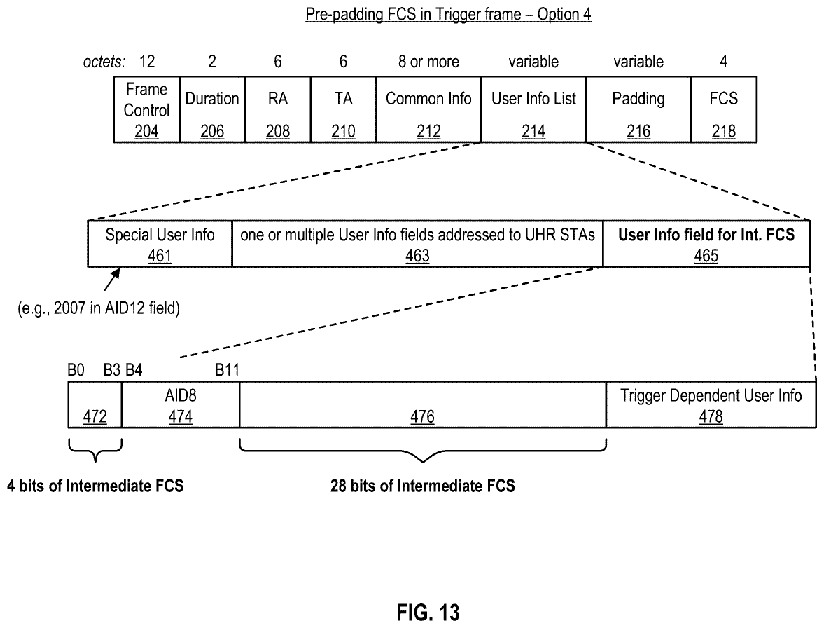

FIG. 13 illustrates another example of a User info List field 214 including an intermediate FCS value in accordance with embodiments of the present disclosure. In this example, the intermediate FCS value is included in the last User Info field of the User Info list field 214. The User Info list field 214 includes a Special User Info field 461 (e.g., including an indication that the trigger frame is an HE variant trigger frame, EHT variant trigger frame, or UHR variant trigger frame), one or multiple User Info fields addressed to UHR STAs 463 (in some examples, EHT/HE STAs may also be addressed), and a User Info field 465 (which may also be referred to herein as an “Intermediate FCS User Info field” or “User Info field for Intermediate FCS”) including an intermediate FCS value. In an example, the intermediate FCS value is calculated over the preceding fields of the trigger frame, and is included in a trigger frame when at least one recipient of the trigger frame enables a feature that requires an early end to decoding of the trigger frame.

In an example, the User Info field 465 includes a 12 bit AID subfield that includes a portion (e.g., 4 bits) of the intermediate FCS value and an AID value portion (e.g., 8 bits) that signals to non-legacy recipient devices that the User Info field 465 carries an intermediate FCS value. In the illustrated example, the AID subfield of the User Info field 465 includes a first subfield 472 (B0-B3) that carries the first 4 bits of an intermediate FCS value and an AID8 subfield 474 (B4-B11) set to a predetermined value or range of values. In this example, the remaining 28 bits of the intermediate FCS value are carried in subfield 476, which is followed by Trigger Dependent User Info subfield 478.

In an example, the AID8 subfield 474 (with B11 set to 0) has a special value such that the value identified by B0-B11 (of the AID subfield of User Info field 465) is greater than 2007 regardless of the value of bits B0-B3 used to carry the first 4 bits of an intermediate FCS value. For example, when combined with bits B0-B3, the values for bits B4-B11 of the AID8 subfield 474 are selected to satisfy the equation Σ_{b4}^{b10}×16+n>2007 where n is any integer from 0 to 15.

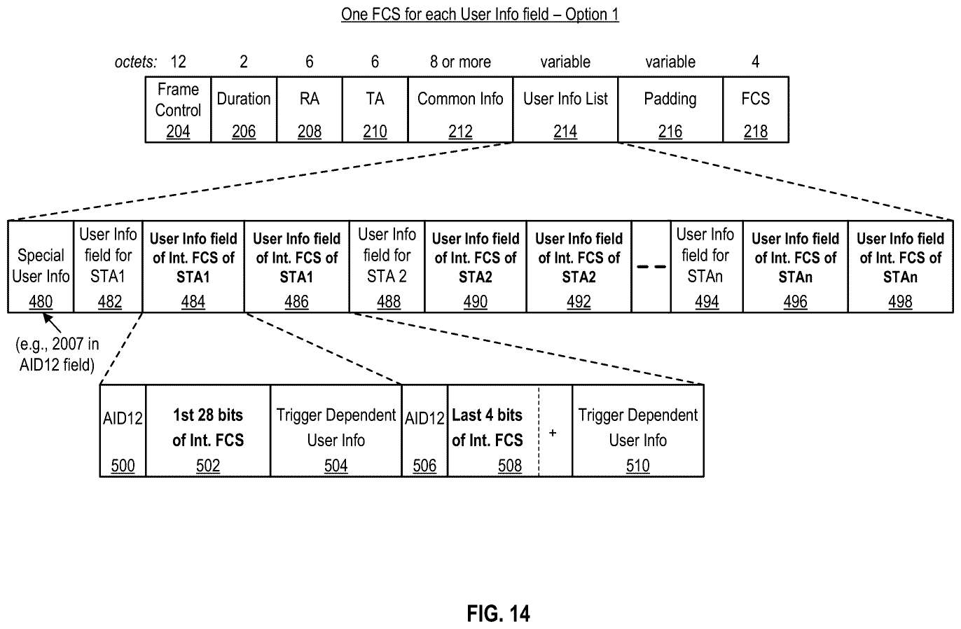

FIG. 14 illustrates an example of User Info fields including intermediate FCS values in accordance with embodiments of the present disclosure. In this example, the trigger frame is addressed to a plurality of HE STAs, EHT STAs or UHR STAs, and a separate intermediate FCS value is provided for each User Info field addressed to a UHR STA. In this manner, a UHR STA being addressed by the trigger frame can stop decoding of the trigger frame at the end of the (pre-padding) intermediate FCS value that immediately follows the User Info field addressed to the UHR STA.

In the illustrated example, the User Info list field 214 includes a Special User Info field 480, a User Info field for STA1 482, a User Info field of intermediate FCS of STA1 484, a User Info field of intermediate FCS of STA1 486, a User Info field for STA2 488, a User Info field of intermediate FCS of STA2 490, a User Info field of intermediate FCS of STA2 492, a User Info field for STAn 494, a User Info field of intermediate FCS of STAn 496, and a User Info field of intermediate FCS of STAn 498.

In this example, the User Info fields 484 and 486 (e.g., “Intermediate FCS User Info fields”) that carry the intermediate FCS value for STA1 include an AID12 subfield 500, the first 28 bits of the intermediate FCS value 502, Trigger dependent User Info 504, AID12 subfield 506, the last 4 bits of the intermediate FCS value 508, and Trigger dependent User Info 510. In an example, the AID12 subfields (e.g., 500 and 506) of each User Info field used to carry an intermediate FCS value for a UHR STA has the same value as the AID12 value of the UHR STA. In another example the AID12 subfields have a special/predetermined value (e.g., 2006).

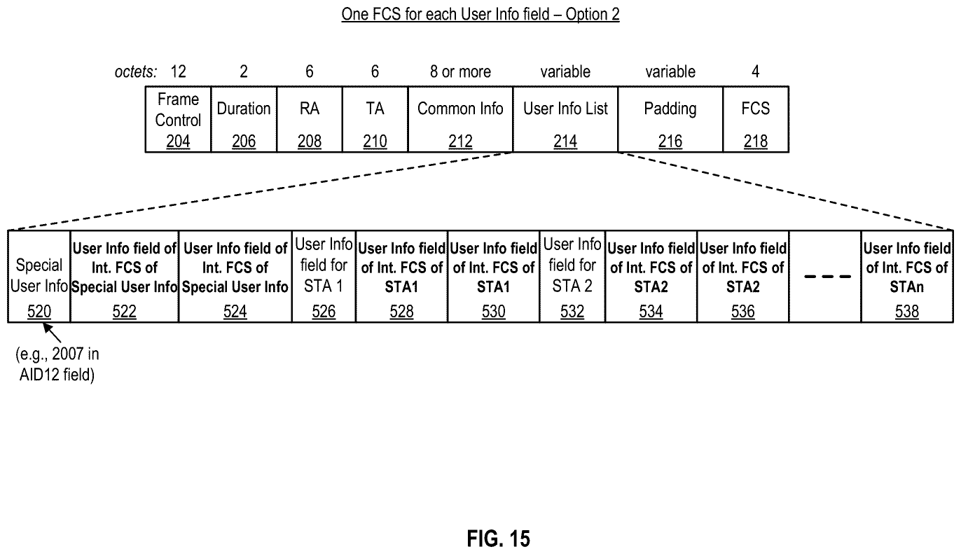

FIG. 15 illustrates an example of a Special User Info field and User Info fields including intermediate FCS values in accordance with embodiments of the present disclosure. The trigger frame of FIG. 15 is similar in format to the trigger frame of FIG. 14, except a separate intermediate FCS value is also calculated for a Special User Info field 520.

In the illustrated example, the User Info list field 214 includes a Special User Info field 520, a User Info field of intermediate FCS of Special User Info 522, a User Info field of intermediate FCS of Special User Info 524, a User Info field for STA1 526, a User Info field of intermediate FCS of STA1 528, a User Info field of intermediate FCS of STA1 530, a User Info field for STA2 532, a User Info field of intermediate FCS of STA2 534, a User Info field of intermediate FCS of STA2 536, etc., and a User Info field of intermediate FCS of STAn 538. The AID12 subfields of the User Info fields (522 and 524) carrying the intermediate FCS value for the Special User Info field 520 may have a value of 2007 or another special/predetermined value (e.g., 2006).

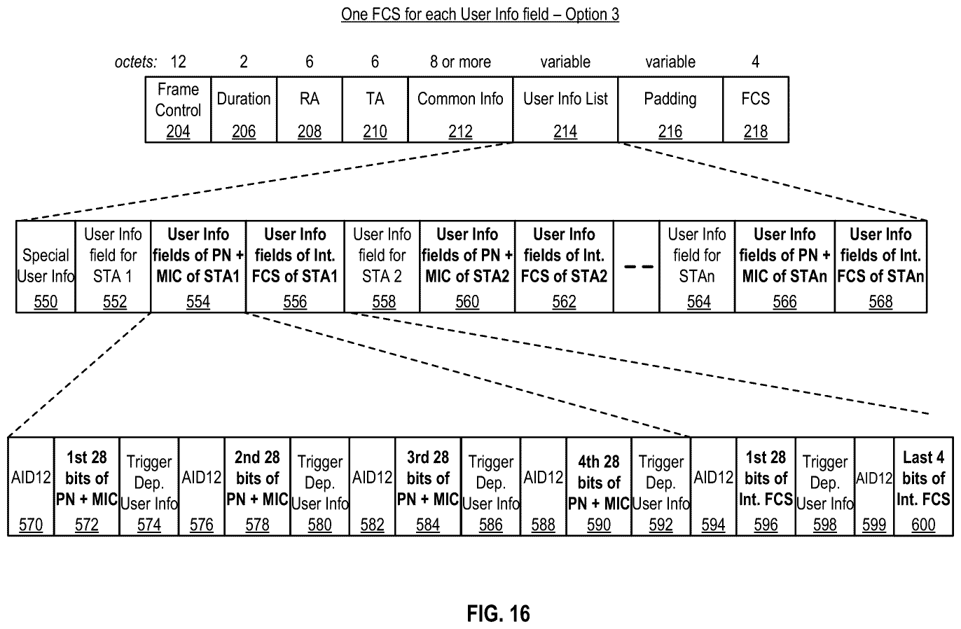

FIG. 16 illustrates an example of User Info fields including intermediate FCS values and PN+MIC values in accordance with embodiments of the present disclosure. The trigger frame of FIG. 16 is similar in format to the trigger frame of FIG. 14, except that the trigger frame is a protected trigger frame and a separate PN+MIC value is included for each UHR STA addressed in the trigger frame.

In the illustrated example, the User Info list field 214 includes a Special User Info field 550, a User Info field for STA1 552, User Info fields of PN+MIC of STA1 554, User Info fields of intermediate FCS of STA1 556, a User Info field for STA2 558, User Info fields of PN+MIC of STA2 560, User Info fields of intermediate FCS of STA2 562, a User Info field for STAn 564, User Info fields of PN+MIC of STAn 566, and User Info fields of intermediate FCS of STAn 568. In an example, a UHR STA being addressed by the illustrated trigger frame can stop decoding the trigger frame at the end of the (pre-padding) intermediate FCS value that follows the User Info field addressed to the UHR STA.

Referring more specifically to the User Info fields of PN+MIC of STA1 554, as an example, the PN+MIC value for STA1 is carried in four User Info fields. These fields include an AID12 subfield 570, the first 28 bits of the PN+MIC value 572, Trigger Dependent User Info subfield 574, AID12 subfield 576, the second 28 bits of the PN+MIC value 578, Trigger Dependent User Info subfield 580, AID12 subfield 582, the third 28 bits of the PN+MIC value 584, Trigger Dependent User Info subfield 586, AID12 subfield 588, the fourth 28 bits of the PN+MIC value 590, and Trigger Dependent User Info Subfield 592. The User Info fields of intermediate FCS of STA1 556 include, for example, AID12 subfield 594, the first 28 bits of the intermediate FCS value (for STA 1) 596, Trigger Dependent User Info subfield 598, AID12 subfield 599, the last 4 bits of the intermediate FCS value 600, and a Trigger Dependent User Info subfield (not separately illustrated). The User Info fields for other addressed UHR STAs are similarly arranged.

In an example, the Trigger Dependent User Info subfields for the User Info fields including the PN+MIC fields and intermediate FCS values follow the same rules as the Trigger Dependent User Info subfield 236 of the Special User Info field 400. In another example, the AID12 values for these User Info fields may correspond to the AID12 values of the associated UHR STAs. In other examples, these AID12 values may have a special/predetermined value(s) (e.g., 2006 or 2008) or a range of values (e.g., ≥2007), or the AID12 values for the User Info fields including PN+MIC fields may have a first predetermined value (e.g., 2005) and the AID 12 values for the User Info fields including intermediate FCS values may have a second predetermined value (e.g., 2006 or 2008) or a range of values (e.g., ≥2008). In addition, a User Info field carrying a PN+MIC value (e.g., “Special User Info For MIC field” or “MIC Special User Info field”) may have the same length as the Special User Info field 550.

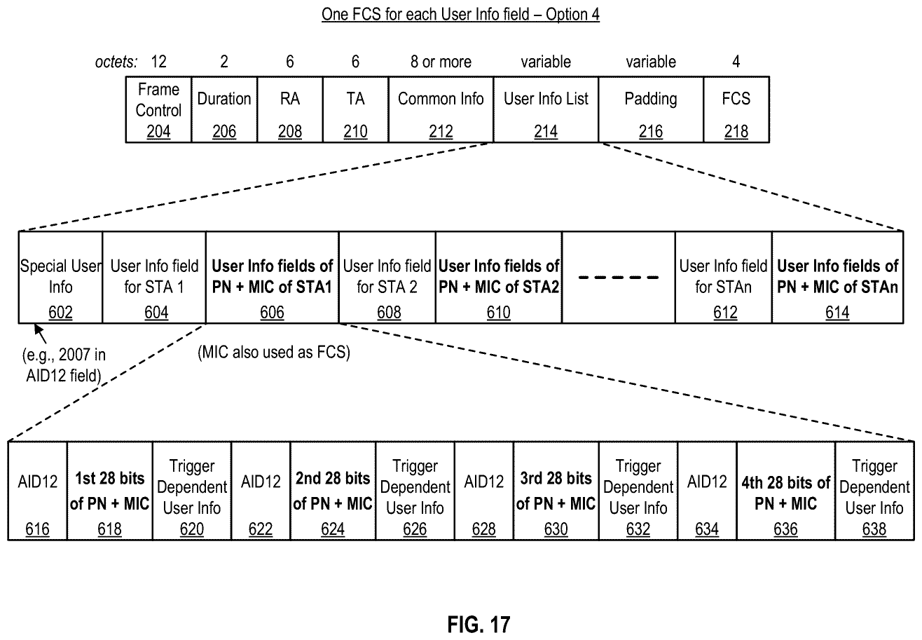

FIG. 17 illustrates an example of User Info fields including a PN+MIC field utilized as an intermediate FCS value in accordance with an embodiment of the present disclosure. In an example, the trigger frame is a protected trigger frame that includes a separate PN+MIC field for each addressed UHR STA. The PN+MIC value for a UHR STA of this embodiment also serves as an intermediate FCS value for the User Info field(s) addressed to the UHR STA.

In the illustrated example, the User Info list field 214 includes a Special User Info field 602, a User Info field for STA1 604, User Info fields of MIC of STA1 606, a User Info field for STA2 608, User Info fields of MIC of STA2 610, a User Info field for STAn 612, and User Info fields of MIC of STAn 614. In an example, a UHR STA being addressed by the illustrated trigger frame can stop decoding the trigger frame at the end of the PN+MIC field that follows the User Info field addressed to the UHR STA.

Referring more specifically to the User Info fields of the PN+MIC of STA1 606, as an example, the PN+MIC field for STA1 is carried in four User Info fields. These fields include an AID12 subfield 616, the first 28 bits of the PN+MIC value 618, Trigger Dependent User Info subfield 620, AID12 subfield 622, the second 28 bits of the PN+MIC value 624, Trigger Dependent User Info subfield 626, AID12 subfield 628, the third 28 bits of the PN+MIC value 630, Trigger Dependent User Info subfield 632, AID12 subfield 634, the fourth 28 bits of the PN+MIC value 636, and Trigger Dependent User Info subfield 638. In an example, the Trigger Dependent User Info subfields for the User Info fields including the PN+MIC values follow the same rules as the Trigger Dependent User Info subfield 236 of the Special User Info field 400. In another example, the AID12 values for these User Info fields may correspond to the AID12 values of the associated UHR STAs. In another example, these AID 12 values may have a special/predetermined value (e.g., 2006 or 2008) or a range of values (e.g., ≥2008).

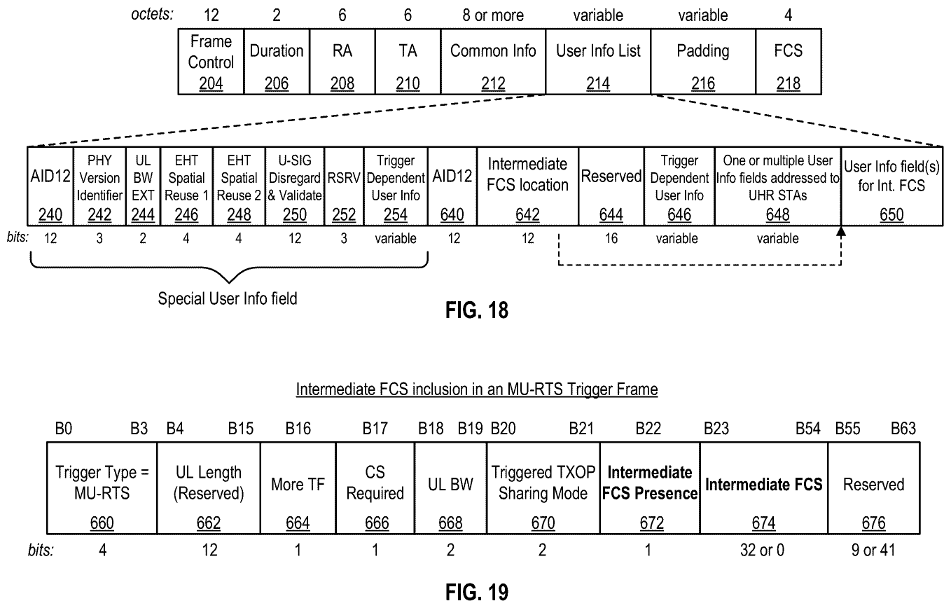

FIG. 18 illustrates an example of a User Info field including an intermediate FCS location field in accordance with an embodiment of the present disclosure. In the illustrated example, the User Info List field 214 of the trigger frame includes a Special User Info field including the subfields 240-254 described above with reference to FIG. 5, a second (Special) User Info field including an AID12 subfield 640, an intermediate FCS location subfield 642, a Reserved subfield 644, and a Trigger Dependent User Info subfield 646, one or multiple User Info fields addressed to UHR STAs 648, and one or more User Info fields 650 that include an intermediate FCS value for the trigger frame (such as described above).

In an example, the intermediate FCS location subfield 642 may be a 12 bit (or other) value that indicates a number of octets from the end of the second User Info field (i.e., from the end of the Reserved subfield 644) to the beginning of the User Info field(s) 650 including the intermediate FCS value for the trigger frame. In another example, the AID 12 subfield 640 for the User Info field including the intermediate FCS location subfield 642 may have the same value (e.g., 2007) as the AID12 subfield 240 for the Special User Info field. Alternatively, the AID12 subfield 640 may have another predetermined value (e.g., 2006 or 2008).

FIG. 19 illustrates an example of a MU-RTS trigger frame including an intermediate FCS value in accordance with an embodiment of the present disclosure. The MU-RTS trigger frame can be used, for example, as an initial control frame that triggers an UHR non-AP STA to switch to another link, another subchannel, and/or extend to a larger bandwidth such as eMLSR/eMLMR, Non-Primary Channel Access, Power Save, Dynamic Subband Operation, etc. In an example, the MU-RTS Trigger frame is used as the initial control frame between an AP affiliated with an AP MLD and a non-AP STA affiliated with a non-AP MLD that is in the EMLSR mode.

In the illustrated example, the MU-RTS trigger frame is identified in a Trigger Type subfield 660 (consisting of 4 bits) of a Common Info field as a MU-RTS trigger frame. The MU-RTS trigger frame of this example further includes an UL Length (reserved) subfield 662 consisting of 12 bits, a More TF subfield 664 consisting of 1 bit, a CS Required subfield 666 consisting of 1 bit, an UL BW subfield 668 consisting of 2 bits, a Triggered TXOP Sharing Mode subfield 670 consisting of 2 bits, an intermediate FCS Presence subfield 672 consisting of 1 bit, an intermediate FCS subfield 674 consisting of 32 bits (or 0 bits if the intermediate FCS is indicated as not present), and a Reserved subfield 676 consisting of 9 bits (or 41 bits if the intermediate FCS is indicated as not present). In an example, the intermediate FCS Presence subfield 672 uses the reserved B22 of the MU-MIMO HE-LTF Mode subfield of a legacy MU-RTS trigger frame, and the intermediate FCS is included in a reserved field of the Common Info field (e.g., from B23 (Number of HE-LTF Symbols and Midamble Periodicity subfield) to B54 (UL HE SIG-A2 Reserved subfield), from B31 to B63 of the Common Info field, etc.)

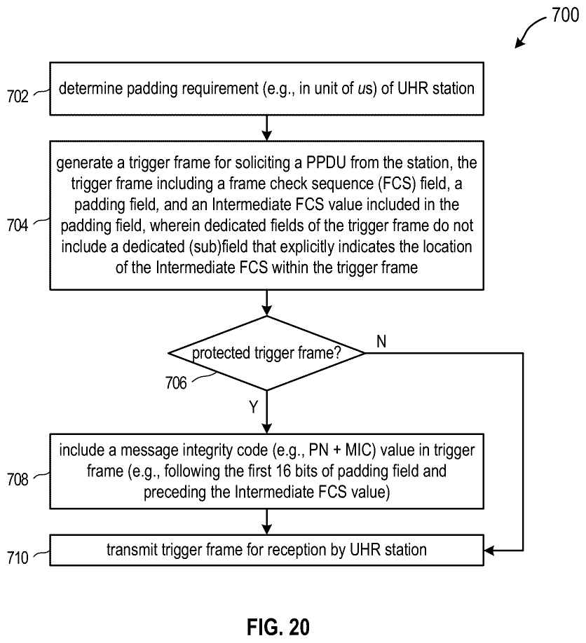

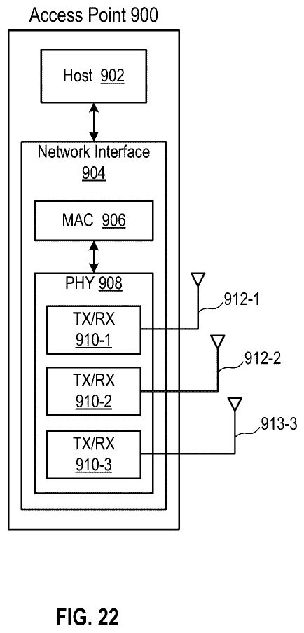

FIG. 20 is a logic diagram illustrating an example process 700 for generating a UHR trigger frame. The process 700 can be performed by an access point (AP), such as the AP MLD 102 described with reference to FIG. 1 or the AP 900 described with reference to FIG. 22. In another example, the process 700 can be similarly performed by a UHR STA (e.g., when generating a UHR MU-RTS for reception by a UHR AP). The process 700 may be utilized, for example, to generate trigger frames such as described with reference to FIGS. 6-9.

The method begins at step 702 where the AP determines a padding requirement (e.g., in units of μs) for a trigger frame for reception by a UHR station(s). In an example, a UHR STA announces its padding requirement for a service that it supports and requires from a trigger frame when the service is enabled (e.g., during the negotiation of the service activation or during an association process). In another example, an AP may announce a padding requirement (e.g., for a UHR MU-RTS variant of a trigger frame) for a service that it supports during negotiation of service activation or via beacon frames.

The method continues at step 704 where the AP generates a trigger frame for soliciting a PPDU from the UHR station. The trigger frame includes a frame check sequence (FCS) field, a padding field, and an intermediate FCS value that is included in the padding field (e.g., following the first two octets of the padding field). In this example, the dedicated fields/subfields of the trigger frame may not include a dedicated field/subfield that explicitly indicates the location of the intermediate FCS value within the trigger frame. As used herein, the term field may also refer to a subfield of a field.

If the trigger frame is not a protected trigger frame as determined at step 706, the method continues at step 710 and the AP transmits the trigger frame for reception by the UHR STA. If the trigger frame is a protected trigger frame as determined at step 706, the AP generates the trigger frame to further include a packet number (PN) and message integrity check (MIC) value (“PN+MIC value”). In a non-limiting example, a PN+MIC value immediately follows the first two octets of the padding field and precedes the intermediate FCS value. The method then proceeds to step 710 where the AP transmits the trigger frame for reception by the UHR station.

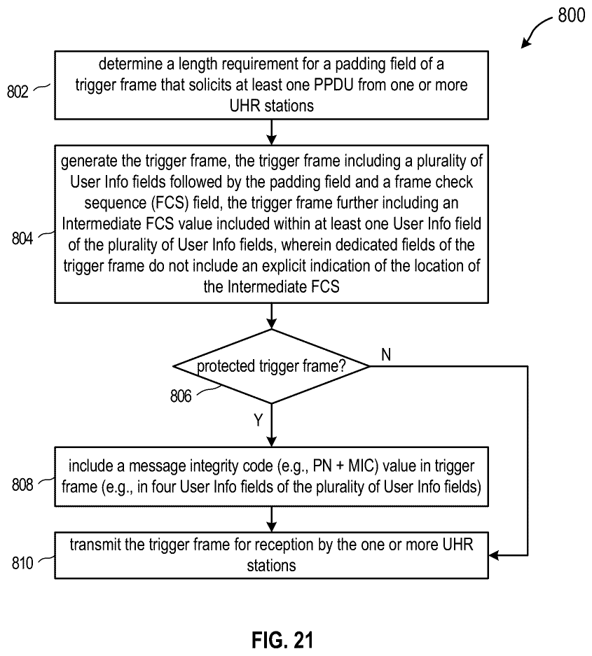

FIG. 21 is a logic diagram illustrating another example process 800 for generating a UHR trigger frame. The process 800 can be performed by an access point (AP), such as the AP MLD 102 described with reference to FIG. 1 or the AP 900 described with reference to FIG. 22. The process 800 may be utilized, for example, to generate trigger frames such as described with reference to FIGS. 10-17.

The method begins at step 802 where the AP determines a length requirement (e.g., in units of μs) for a padding field of a trigger frame that solicits at least one PPDU from one or more UHR stations. The method continues at step 804, where the AP generates a trigger frame, the trigger frame including a plurality of User Info fields followed by the padding field and a frame check sequence (FCS) field. The trigger frame further includes an intermediate FCS value included within at least one User Info field of the plurality of User Info fields (e.g., in the last one or two User Info fields of the trigger frame). In this example, the dedicated fields/subfields of the trigger frame may not include a dedicated field/subfield that explicitly indicates the location of the intermediate FCS value within the trigger frame.

If the trigger frame is not a protected trigger frame as determined at step 806, the method continues at step 810 and the AP transmits the trigger frame for reception by one or more UHR STAs. If the trigger frame is a protected trigger frame as determined at step 806, the AP generates the trigger frame to further include a packet number (PN) and message integrity check (MIC) value (“PN+MIC value”). In a non-limiting example, a PN+MIC value is included in four User Info fields that precede the at least one User Info field containing the UHR FCS value. The method then proceeds to step 810 where the AP transmits the trigger frame for reception by one or more UHR STAs.

FIG. 22 illustrates an example of a wireless network device that is configured as an access point (AP) 900 according to an embodiment of the present disclosure. The AP 900 is configurable to generate a UHR trigger frame according to any of the various embodiments described herein. The illustrated AP 900 includes a host processor 902 coupled to a network interface device 904. The network interface device 904 includes a medium access control (MAC) processing unit 906 and a physical layer (PHY) processing unit 908. The PHY processing unit 908 includes a plurality of transceivers 910 coupled to a plurality of antennas 912. Although three transceivers 910 (910-1, 910-2 and 910-3) and three antennas 912 (912-1, 912-2 and 912-3) are illustrated in FIG. 1, the AP 900 includes other suitable numbers (e.g., 1, 2, 4, 5, etc.) of transceivers 910 and antennas 912 in other embodiments. In an example, the MAC processing unit 906 and the PHY processing unit 908 are configured to operate in compliance with the IEEE 802.11bn amendment to the IEEE 802.11 standard. In an example, the network interface device 904 includes one or more integrated circuit (IC) devices. In this example, at least some of the functionality of the MAC processing unit 906 and at least some of the functionality of the PHY processing unit 908 can be implemented on a single IC device. As another example, at least some of the functionality of the MAC processing unit 906 is implemented on a first IC device, and at least some of the functionality of the PHY processing unit 908 is implemented on a second IC device. The AP 900 may communicate (e.g., trigger-based communications) with a plurality of client stations (not separately illustrated), including both legacy and non-legacy client stations.

In various embodiments, the PHY processing unit 908 of the AP 900 is configured to generate data units conforming to a non-legacy communication protocol and having formats described herein. The transceiver(s) 910 is/are configured to transmit the generated data units via the antenna(s) 912. Similarly, the transceiver(s) 910 is/are configured to receive data units via the antenna(s) 912. The PHY processing unit 908 of the AP 900 is configured to process received data units conforming to the non-legacy communication protocol and having formats described herein and to determine that such data units conform to the non-legacy communication protocol.

In an embodiment, when operating in single-user mode, the AP 900 transmits a data unit to a single client station (DL SU transmission), or receives a data unit transmitted by a single client station (UL SU transmission), without simultaneous transmission to, or by, any other client station. When operating in multi-user mode, the AP 900 transmits a data unit that includes multiple data streams for multiple client stations (DL MU transmission), or receives data units simultaneously transmitted by multiple client stations (UL MU transmission). For example, in multi-user mode, a data unit transmitted by the AP includes multiple data streams simultaneously transmitted by the AP 900 to respective client stations using respective spatial streams allocated for simultaneous transmission to the respective client stations and/or using respective sets of OFDM tones corresponding to respective frequency sub-channels allocated for simultaneous transmission to the respective client stations. In a further example, the AP 900 may be configured as a multi-link device, such as the AP MLD 102 described above with reference to FIG. 1.

While the innovate aspects of the present disclosure have been generally described in the context of the 802.11bn amendment, and future generations, of the IEEE 802.11 standard, a person having ordinary skill in the art will readily recognize that teachings herein may be applied to other wireless networks and standards including, for example, Long Term Evolution (LTE) standards and Bluetooth standards.

The innovative methods and apparatus illustrated in the drawings and described herein provide for a trigger frame that can be decoded correctly by non-UHR STAs. In an illustrative, non-limiting embodiment, a method for wireless communication by a wireless communication device is provided. The method includes determining, by a first device, a length requirement for a padding field of a trigger frame. The method further includes generating, by the first device, the trigger frame for soliciting a physical layer (PHY) protocol data unit (PPDU) from a second device, the trigger frame including a frame check sequence (FCS) field, a padding field, and an intermediate FCS value. The intermediate FCS value is included in the padding field.

The method of this embodiment includes optional aspects. With one optional aspect, the intermediate FCS value follows the first 16 bits of the padding field of the trigger frame. With another optional aspect, the trigger frame is a protected trigger frame further including a message integrity check (MIC) value, and the PN+MIC value immediately follows the first 16 bits of the padding field and the intermediate FCS value follows the PN+MIC field. In yet another optional aspect, the trigger frame is a protected trigger frame further including a PN+MIC field, and the intermediate FCS value immediately follows the first 16 bits of the padding field and the PN+MIC field follows the intermediate FCS value.

With another illustrative, non-limiting embodiment, a method for wireless communication by a wireless communication device is provided. The method includes determining, by a first device, a length requirement for a padding field of a trigger frame that solicits at least one physical layer (PHY) protocol data unit (PPDU) from one or more Ultra High Reliability (UHR) stations. The method further includes generating the trigger frame by the first device, the trigger frame including a plurality of User Info fields followed by the padding field and a frame check sequence (FCS) field, the trigger frame further including an intermediate FCS value included within at least one User Info field of the plurality of User Info fields.

This embodiment includes optional aspects. With one optional aspect, the at least one User Info field that include the intermediate FCS value are two consecutive User Info fields that each include an association ID (AID) subfield set to a predetermined value, the two consecutive User Info fields immediately preceding the padding field. In another optional aspect, the at least one User Info field includes the intermediate FCS value is a single User Info field having an association ID (AID) subfield with a value greater than 2007. In still another optional aspect, the trigger frame further includes padding bits for the one or more UHR stations, and the padding bits immediately follow the at least one User Info field including the intermediate FCS value.

In yet another optional aspect, the trigger frame is a protected trigger frame further including a packet number and message integrity check value (PN+MIC value) included within four User Info fields of the plurality User Info fields. In this optional aspect, the four User Info fields including the PN+MIC field may precede the two User Info fields including the intermediate FCS value, and each of the four User Info fields include an AID subfield set to a predetermined value.

With another illustrative, non-limiting embodiment, a communication device includes one or more wireless transceivers, memory including operational instructions, and one or more processing modules operably coupled to the one or more wireless transceiver and the memory. The one or more processing modules are configured to execute the operational instructions to determine a length requirement for a padding field of a trigger frame that solicits at least one physical layer (PHY) protocol data unit (PPDU) from one or more client stations and generate the trigger frame, the trigger frame including a frame check sequence (FCS) field, the padding field, and an intermediate FCS value. The intermediate FCS value is included in the padding field. The one or more processing modules of the communication device are further configured to transmit the trigger frame via the one or more wireless transceivers.

This third embodiment includes optional aspects. With one optional aspect, the intermediate FCS value immediately follows the first 16 bits of the padding field. In another optional aspect, the trigger frame is a protected trigger frame further including a packet number and message integrity check value (PN+MIC value), wherein the PN+MIC value immediately follows the first 16 bits of the padding of the padding field and the intermediate FCS value follows the PN+MIC value. In still another option aspect, the trigger frame is a protected trigger frame further including a packet number and PN+MIC value, wherein the PN+MIC value immediately follows the first 16 bits of the padding field and the PH+MIC value follows the intermediate FCS value.

With another illustrative, non-limiting embodiment, a communication device includes one or more wireless transceivers, memory including operational instructions, and one or more processing modules operably coupled to the one or more wireless transceiver and the memory. The one or more processing modules are configured to execute the operational instructions to determine a length requirement for a padding field of a trigger frame that solicits at least one physical layer (PHY) protocol data unit (PPDU) from one or more client stations and generate the trigger frame, the trigger frame including a plurality of User Info fields followed by the padding field and a frame check sequence (FCS) field, the trigger frame further including an Ultra High Reliability (UHR) FCS value included within at least one User Info field of the plurality of User Info fields. The one or more processing modules of the communication device are further configured to transmit the trigger frame via the one or more wireless transceivers.

This embodiment includes optional aspects. With one optional aspect, the at least one User Info field that includes the intermediate FCS value are two consecutive User Info fields that each include an association ID (AID) subfield set to a predetermined value and immediately precede the padding field. In another optional aspect, the at least one User Info field including the intermediate FCS value is a single User Info field having an association ID (AID) value greater than 2007. In still another optional aspect, the trigger frame further includes padding bits for the one or more client stations, and the padding bits immediately follow the at least one User Info field including the intermediate FCS value.

In yet another optional aspect, the trigger frame is a protected trigger frame further including a packet number and message integrity check value (PN+MIC value) included within four User Info fields of the plurality User Info fields. In another optional aspect, the four User Info fields including the PN+MIC value precede the at least one User Info field including the intermediate FCS value, and each of the four User Info fields include an AID subfield set to a predetermined value.

To implement various operations described herein, computer program code (i.e., program instructions for carrying out these operations) may be written in any combination of one or more programming languages, including an object-oriented programming language such as Java, Smalltalk, Python, C++, or the like, conventional procedural programming languages, such as the “C” programming language or similar programming languages, or any of machine learning software. These program instructions may also be stored in a computer readable storage medium that can direct a computer system, other programmable data processing apparatus, controller, or other device to operate in a particular manner, such that the instructions stored in the computer readable medium produce an article of manufacture including instructions which implement the operations specified in the block diagram block or blocks. The program instructions may also be loaded onto a processing core, processing circuitry, computer, other programmable data processing apparatus, controller, or other device to cause a series of operations to be performed on the computer, or other programmable apparatus or devices, to produce a computer implemented process such that the instructions upon execution provide processes for implementing the operations specified in the block diagram block or blocks.

As may be used herein, the term(s) “configured to”, “operably coupled to”, “coupled to”, and/or “coupling” includes direct coupling between items and/or indirect coupling between items via an intervening item (e.g., an item includes, but is not limited to, a component, an element, a circuit, and/or a module) where, for an example of indirect coupling, the intervening item does not modify the information of a signal but may adjust its current level, voltage level, and/or power level. As may further be used herein, inferred coupling (i.e., where one element is coupled to another element by inference) includes direct and indirect coupling between two items in the same manner as “coupled to”.

As may further be used herein, the term(s) “configured to”, “operable to”, “coupled to”, or “operably coupled to” indicates that an item includes one or more of power connections, input(s), output(s), etc., to perform, when activated, one or more its corresponding functions and may further include inferred coupling to one or more other items. As may still further be used herein, the term “associated with”, includes direct and/or indirect coupling of separate items and/or one item being embedded within another item.

As may be used herein, one or more claims may include, in a specific form of this generic form, the phrase “at least one of a, b, and c” or of this generic form “at least one of a, b, or c”, with more or less elements than “a”, “b”, and “c”. In either phrasing, the phrases are to be interpreted identically. In particular, “at least one of a, b, and c” is equivalent to “at least one of a, b, or c” and shall mean a, b, and/or c. As an example, it means: “a” only, “b” only, “c” only, “a” and “b”, “a” and “c”, “b” and “c”, and/or “a”, “b”, and “c”.

As may also be used herein, the terms “processor”, “processing circuitry”, “processing circuit”, “processing module”, and/or “processing unit” may be a single processing device or a plurality of processing devices. Such a processing device may be a microprocessor, microcontroller, digital signal processor, microcomputer, central processing unit, field programmable gate array, programmable logic device, state machine, logic circuitry, analog circuitry, digital circuitry, and/or any device that manipulates signals (analog and/or digital) based on hard coding of the circuitry and/or operational instructions. Further, such a processing device may include a plurality of processing cores or processing domains, which may operate on separate power domains. The processor, processing circuitry, processing circuit, processing module, and/or processing unit may be (or may further include) memory and/or an integrated memory element, which may be a single memory device, a plurality of memory devices, and/or embedded circuitry of another processor, processing circuitry, processing circuit, processing module, and/or processing unit. Such a memory device may be a read-only memory, random access memory, volatile memory, non-volatile memory, static memory, dynamic memory, flash memory, cache memory, and/or any device that stores digital information. Note that if the processor, processing circuitry, processing circuit, processing module, and/or processing unit includes more than one processing device, the processing devices may be centrally located (e.g., directly coupled together via a wired and/or wireless bus structure) or may be distributedly located (e.g., cloud computing via indirect coupling via a local area network and/or a wide area network). Further note that if the processor, processing circuitry, processing circuit, processing module, and/or processing unit implements one or more of its functions via a state machine, analog circuitry, digital circuitry, and/or logic circuitry, the memory and/or memory element storing the corresponding operational instructions may be embedded within, or external to, the circuitry comprising the state machine, analog circuitry, digital circuitry, and/or logic circuitry. Still further note that, the memory element may store, and the processor, processing circuitry, processing circuit, processing module, and/or processing unit executes, hard coded and/or operational instructions corresponding to at least some of the steps and/or functions illustrated in one or more of the figures. Such a memory device or memory element can be included in an article of manufacture.

One or more embodiments have been described above with the aid of method steps illustrating the performance of specified functions and relationships thereof. The boundaries and sequence of these functional building blocks and method steps have been arbitrarily defined herein for convenience of description. Alternate boundaries and sequences can be defined so long as the specified functions and relationships are appropriately performed. Any such alternate boundaries or sequences are thus within the scope and spirit of the claims.

To the extent used, the logic diagram block boundaries and sequence could have been defined otherwise and still perform the certain significant functionality. Such alternate definitions of both functional building blocks and logic diagram blocks and sequences are thus within the scope and spirit of the claims. One of average skill in the art will also recognize that the functional building blocks, and other illustrative blocks, modules and components herein, can be implemented as illustrated or by discrete components, application specific integrated circuits, processors/processing cores executing appropriate software and the like or any combination thereof.

The one or more embodiments are used herein to illustrate one or more aspects, one or more features, one or more concepts, and/or one or more examples. A physical embodiment of an apparatus, an article of manufacture, a machine, and/or of a process may include one or more of the aspects, features, concepts, examples, etc. described with reference to one or more of the embodiments discussed herein. Further, from figure to figure, the embodiments may incorporate the same or similarly named functions, steps, modules, etc. that may use the same or different reference numbers and, as such, the functions, steps, modules, etc. may be the same or similar functions, steps, modules, etc. or different ones.

The term “module” may be used in the description of one or more of the embodiments. A module implements one or more functions via a device such as a processor or other processing device or other hardware that may include or operate in association with a memory that stores operational instructions. A module may operate independently and/or in conjunction with software and/or firmware. As also used herein, a module may contain one or more sub-modules, each of which may be one or more modules.

As may further be used herein, a computer readable memory includes one or more memory elements. A memory element may be a separate memory device, multiple memory devices, or a set of memory locations within a memory device. Such a memory device may be a read-only memory, random access memory, volatile memory, non-volatile memory, static memory, dynamic memory, flash memory, cache memory, a quantum register or other quantum memory and/or any other device that stores data in a non-transitory manner. Furthermore, the memory device may be in a form of a solid-state memory, a hard drive memory or other disk storage, cloud memory, thumb drive, server memory, computing device memory, and/or other non-transitory medium for storing data. The storage of data includes temporary storage (i.e., data is lost when power is removed from the memory element) and/or persistent storage (i.e., data is retained when power is removed from the memory element). As used herein, a transitory medium shall mean one or more of: (a) a wired or wireless medium for the transportation of data as a signal from one computing device to another computing device for temporary storage or persistent storage; (b) a wired or wireless medium for the transportation of data as a signal within a computing device from one element of the computing device to another element of the computing device for temporary storage or persistent storage; (c) a wired or wireless medium for the transportation of data as a signal from one computing device to another computing device for processing the data by the other computing device; and (d) a wired or wireless medium for the transportation of data as a signal within a computing device from one element of the computing device to another element of the computing device for processing the data by the other element of the computing device. As may be used herein, a non-transitory computer readable memory is substantially equivalent to a computer readable memory. A non-transitory computer readable memory can also be referred to as a non-transitory computer readable storage medium.

While particular combinations of various functions and features of the one or more embodiments have been expressly described herein, other combinations of these features and functions are likewise possible. The present disclosure is not limited by the particular examples disclosed herein and expressly incorporates these other combinations.

What is claimed is:

1. A method for wireless communication, comprising:
determining, by a first device, a length requirement for a padding field of a trigger frame; and
generating, by the first device, the trigger frame for soliciting a physical layer (PHY) protocol data unit (PPDU) from a second device, the trigger frame including a frame check sequence (FCS) field, a padding field, and an intermediate FCS value, wherein the intermediate FCS value is included in the padding field.

2. The method of claim 1, wherein the intermediate FCS value follows the first 16 bits of the padding field.

3. The method of claim 1, wherein the trigger frame is a protected trigger frame further including a packet number and message integrity check value (PN+MIC value), wherein the PN+MIC value immediately follows the first 16 bits of the padding field and the intermediate FCS value follows the PN+MIC value.

4. The method of claim 1, wherein the trigger frame is a protected trigger frame further including a packet number and message integrity check value (PN+MIC value), wherein the intermediate FCS value immediately follows the first 16 bits of the padding field and the PN+MIC value follows the intermediate FCS value.

5. A method for wireless communication, comprising:
determining, by a first device, a length requirement for a padding field of a trigger frame that solicits at least one physical layer (PHY) protocol data unit (PPDU) from one or more Ultra High Reliability (UHR) stations; and
generating the trigger frame by the first device, the trigger frame including a plurality of User Info fields followed by the padding field and a frame check sequence (FCS) field, the trigger frame further including an intermediate FCS value included within at least one User Info field of the plurality of User Info fields.

6. The method of claim 5, wherein the at least one User Info field that includes the intermediate FCS value are two consecutive User Info fields that each include an association ID (AID) subfield set to a predetermined value, and wherein the two consecutive User Info fields immediately precede the padding field.

7. The method of claim 5, wherein the at least one User Info field including the intermediate FCS value is a single User Info field having an association ID (AID) subfield with a value greater than 2007.

8. The method of claim 5, wherein the trigger frame further includes padding bits for one or more client stations addressed by the trigger frame, and wherein the padding bits immediately follow the at least one User Info field including the intermediate FCS value.

9. The method of claim 5, wherein the trigger frame is a protected trigger frame further including a packet number and message integrity check value (PN+MIC value), wherein the PN+MIC value is included within four User Info fields of the plurality of User Info fields.

10. The method of claim 9, wherein the four User Info fields including the PN+MIC value precede the at least one User Info field including the intermediate FCS value, and wherein each of the four User Info fields include an AID subfield set to a predetermined value.

11. A communication device, comprising:
one or more wireless transceivers;
memory including operational instructions; and
one or more processing modules operably coupled to the one or more wireless transceivers and the memory, wherein the one or more processing modules are configured to execute the operational instructions to:
determine a length requirement for a padding field of a trigger frame that solicits at least one physical layer (PHY) protocol data unit (PPDU) from one or more client stations;
generate the trigger frame, the trigger frame including a frame check sequence (FCS) field, the padding field, and an intermediate FCS value, wherein the intermediate FCS value is included in the padding field; and
transmit the trigger frame via the one or more wireless transceivers.

12. The communication device of claim 11, wherein the intermediate FCS value immediately follows the first 16 bits of the padding field.

13. The communication device of claim 11, wherein the trigger frame is a protected trigger frame further including a packet number and message integrity check value (PN+MIC value), wherein the PN+MIC value immediately follows the first 16 bits of the padding field and the intermediate FCS value follows the PN+MIC value.

14. The communication device of claim 11, wherein the trigger frame is a protected trigger frame further including a packet number and message integrity check value (PN+MIC value), wherein the intermediate FCS value immediately follows the first 16 bits of the padding field and the PN+MIC value follows the intermediate FCS value.

15. A communication device, comprising:
one or more wireless transceivers;
memory including operational instructions; and
one or more processing modules operably coupled to the one or more wireless transceivers and the memory, wherein the one or more processing modules are configured to execute the operational instructions to:
determine a length requirement for a padding field of a trigger frame that solicits at least one physical layer (PHY) protocol data unit (PPDU) from one or more client stations;
generate the trigger frame, the trigger frame including a plurality of User Info fields followed by the padding field and a frame check sequence (FCS) field, the trigger frame further including an intermediate FCS value included within at least one User Info field of the plurality of User Info fields; and
transmit the trigger frame via the one or more wireless transceivers.

16. The communication device of claim 15, wherein the at least one User Info field that includes the intermediate FCS value are two consecutive User Info fields that each include an association ID (AID) subfield set to a predetermined value, and wherein the two consecutive User Info fields immediately precede the padding field.

17. The communication device of claim 15, wherein the at least one User Info field including the intermediate FCS value is a single User Info field having an association ID (AID) subfield with a value greater than 2007.

18. The communication device of claim 15, wherein the trigger frame further includes padding bits for the one or more client stations, and wherein the padding bits immediately follow the at least one User Info field including the intermediate FCS value.

19. The communication device of claim 15, wherein the trigger frame is a protected trigger frame further including a packet number and message integrity check value (PN+MIC value), wherein the PN+MIC value is included within four User Info fields of the plurality of User Info fields.

20. The communication device of claim 19, wherein the four User Info fields including the PN+MIC value precede the at least one User Info field including the intermediate FCS value, and wherein each of the four User Info fields include an AID subfield set to a predetermined value.
